(19) United States
(12) Patent Application Publication
(10) Pub. No.: US 2006/0009243 A1
(43) Pub. Date: Jan. 12, 2006

(54) Always-on mobile instant messaging of a messaging centric wireless device

(75) Inventors: Andre Dahan, New York, NY (US); David Brudnicki, Duvall, WA (US); Ivy Cunningham, Seattle, WA (US); Stacia Lynn Pache, Redmond, WA (US); Christopher White, Redmond, WA (US)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: AT&T Wireless Services, Inc., Redmond, WA (US)

(21) Appl. No.: 10/939,103

(22) Filed: Sep. 10, 2004

Related U.S. Application Data
(60) Provisional application No. 60/590,229, filed on Jul. 21, 2004.
(60) Provisional application No. 60/588,018, filed on Jul. 12, 2004.
(60) Provisional application No. 60/587,792, filed on Jul. 12, 2004.
(60) Provisional application No. 60/588,307, filed on Jul. 15, 2004.
(60) Provisional application No. 60/588,110, filed on Jul. 15, 2004.
(60) Provisional application No. 60/585,965, filed on Jul. 7, 2004.
(60) Provisional application No. 60/590,185, filed on Jul. 21, 2004.

(51) Int. Cl. H04Q 7/20

(52) U.S. Cl. 455/466

(57) ABSTRACT

A messaging-centric wireless device that communicates messages in the form of e-mail, SMS, and instant messaging. One of the core capabilities of the device is to support always-on mobile instant messaging, including reasonably accurate IM status information. The device/service includes some or all of the following features: IM community aggregation; intelligent IM status; a dedicated network environment (PDP/APN); an always-on connection either through a sustained wireless data connection or through buffered/mediated services that use out-of-band signaling to initiate a PDP context; an IM gateway to aggregate IM and/or e-mail connectivity; self-provisioning; the capability to compose messages without having to indicate dependent aspects of the message such as delivery bearer; a messaging oriented physical design; the capability to add on voice service; and, the capability to add on other data services.

### CROSS-REFERENCE TO RELATED APPLICATIONS

This application claims the benefit of the following U.S. Provisional Patent Applications: Ser. No. 60/590,229 entitled “ALWAYS-ON MOBILE INSTANT MESSAGING OF A MESSAGING CENTRIC WIRELESS DEVICE” filed on Jul. 21, 2004; Ser. No. 60/588,018 entitled “MAINTAINING INSTANT MESSAGE SESSION STATUS IN DYNAMIC OPERATING ENVIRONMENTS” filed on Jul. 11, 2004; Ser. No. 60/587,792 entitled “SELECTION OF BEARER MODE ACCORDING TO MESSAGE CHARACTERISTICS” filed on Jul. 11, 2004; Ser. No. 60/588,307 entitled “USING EMOTICONS, SUCH AS FOR WIRELESS DEVICES” filed on Jul. 15, 2004; Ser. No. 60/588,110 entitled “CUSTOMER SERVICE MESSAGING, SUCH AS ON MOBILE DEVICES” filed on Jul. 15, 2004; Ser. No. 60/585,965 entitled “SYSTEM AND METHOD FOR DATA ORGANIZATION AND DISPLAY IN AN INSTANT MESSAGING INTERFACE” filed on Jul. 7, 2004; and, Ser. No. 60/590,185 entitled “DEDICATED WIRELESS DEVICE BUSINESS MODEL” filed on Jul. 21, 2004. The entireties of the above-noted applications are incorporated herein by reference.

### TECHNICAL FIELD

This invention is related to wireless messaging, and more specifically, wireless messaging centric devices.

### BACKGROUND OF THE INVENTION

Instant Messaging (IM) is a technology that allows users to send and receive short text messages in real time over IP networks. It also allows the user to signal their online presence to others by simply launching a messaging client and/or logging in to the client. IM has been in general use for some time, beginning with a product known as ICQ™ by ICQ, Inc., a messaging service now offered in a variety of flavors and used for many purposes, both commercial and personal, that take advantage of the real time messaging capability and presence management features of IM.

Though instant messaging is perceived by users to be a Peer-to-Peer (P2P) application, directly connecting the user with chat “buddies”, IM actually depends upon a client-server architecture to facilitate those apparently direct interactions. When logging on, the user IM software client tells the IM server who the user is and where the user is via a screen name and current IP address. The server then updates its directory information to indicate that the user is online and available. The server shows the user which buddies are online, and it lets people who have added the user to their buddy lists, see that the user is online. Unlike e-mail and other asynchronous collaboration tools, IM works in real time, giving the user a channel to buddies that hides their contact details, as well as, their physical location and mode of connection (e.g., laptop, Palm device, mobile phone, and so on).

It is natural for mobile users to desire access to mail and communicate in a data-centric manner while mobile. Messaging is used for quick person-to-person social coordination, often involves time-sensitive information, and utilizes presence indicators to help users keep track of their friends' status. Additionally, there is a strong demand for mobile messaging services. Nearly half of all IM users indicate that the option to use IM while mobile is desirable. Moreover, mobile e-mail is one of the top applications on mMode™ today. mMode, by AT&T Wireless Services, Inc., brings together e-mail, Internet-based content, games, and more, all in one place on the wireless telephone.

However, usage and penetration for the mobile population at large, remains low. Some of the main deterrents to the adoption of mobile messaging services are device limitations (such as small screens, text input from numeric keypads, messaging task management), lack of acceptable pricing plans and device pricing, failure of messaging applications to maintain consistency with the desktop experience, and cumbersome purchase experience.

Currently, customers must think about messaging/data plans as an addition to voice. This creates an additional level of complexity for the customer in terms of pricing and marketing messages. If customers succeed in purchasing a messaging plan, actually using the e-mail/IM applications is a less than ideal customer experience.

GPRS (General Packet Radio Service) is an industry-standard technology for enhancing GSM (Global System for Mobile Communications) digital networks with “always-on” high-speed connections to a new generation of Internet-capable mobile devices. The GPRS technology is a component of a network that complements its circuit-switched voice network with a capability for efficiently carrying packets of data in accordance with Internet Protocols (IP). GPRS enables access to high speed wireless data services and paves the way to enhanced applications accessed over third generation (3G) UMTS (Universal Mobile Telecommunications Services) wireless systems.

Given that most wireless devices are voice-centric with the addition of some messaging capabilities, there is an unmet need in the market today for a consumer wireless messaging-centric device that focuses on e-mail, instant messaging, text messaging, and other messaging technologies in an always-on environment.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention creates a new category of mobile device that focuses on the extension of the desktop messaging experience into the mobile environment.

The invention disclosed and claimed herein, in one aspect thereof, comprises a messaging-centric wireless device that highlights at least e-mail, SMS (Short Message Service), and instant messaging. One of the core capabilities of the device is to support always-on mobile instant messaging, such that the online presence of a user of the device can be immediately known, as provided by reasonably accurate IM status information. The device/service includes some or all of the following features: the capability to send and receive SMS messages; send and receive e-mail messages from multiple e-mail accounts; send and receive instant messaging messages from multiple e-mail accounts; send and receive instant messaging messages from multiple IM providers; IM community aggregation; intelligent IM status; a dedicated network environment (PDP-Packet Data Protocol)/APN-Access Point Name); an always-on connection either through a sustained wireless data connection or through buffered/mediated services that use out-of-band signaling to initiate a PDP context; an IM gateway to aggregate IM and/or e-mail connectivity; self-provisioning; the capability to compose messages without having to indicate dependent aspects of the message such as delivery bearer; a messaging oriented physical design; the capability to add on voice service; and, the capability to add on other data services.

In another aspect thereof, the wireless device can be activated out-of-the box via an activation wizard with no contract.

In yet another aspect of the invention, the device provides the capability to the user to personalize or customize their device according to the ringer, Alerticons, buddy tones, and IM emoticons, for example.

In still another aspect thereof, the user can move quickly between data applications (e.g., chats and e-mail) via a graphical user interface.

To the accomplishment of the foregoing and related ends, certain illustrative aspects of the invention are described herein in connection with the following description and the annexed drawings. These aspects are indicative, however, of but a few of the various ways in which the principles of the invention may be employed and the invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 illustrates a wireless messaging device (WMD) that facilitates always-on message processing in accordance with the invention.

FIG. 2 illustrates a general diagram of the types of messages that can be communicated with the WMD of the invention.

FIG. 3 illustrates some of the capabilities provided in the WMD of the invention.

FIG. 4 illustrates a flow chart of one methodology for providing a message-centric system in accordance with the invention.

FIG. 5 illustrates a methodology of provisioning and activation of the WMD in accordance with the invention.

FIG. 6 illustrates a methodology for IM and e-mail account setup according to one aspect of the invention.

FIG. 7 illustrates a methodology of providing a homepage interface for the WMD of the invention.

FIG. 8 illustrates a methodology associated with an SMS application to provide SMS functionality in accordance with the invention.

FIG. 9 illustrates a methodology associated with an e-mail application to provide e-mail functionality in accordance with the invention.

FIG. 10 illustrates a methodology associated with an IM application to provide instant messaging functionality in accordance with the invention.

FIG. 11 illustrates a methodology associated with a contacts application to provide contact functionality in accordance with the invention.

FIG. 12 illustrates a front view of one implementation of a WMD in accordance with the invention.

FIG. 13 illustrates an isometric of the WMD of FIG. 12.

FIG. 14 illustrates one implementation of a keyboard that can be employed with the WMD of the invention.

FIG. 15 illustrates a screenshot of a Home screen in accordance with the user interface of the invention.

FIG. 16 illustrates a screenshot of an IM Buddies screen in accordance with the user interface of the invention.

FIG. 17 illustrates a screenshot of a Compose screen in accordance with the user interface of the invention.

FIG. 18 illustrates a screenshot of a Mailbox screen in accordance with the user interface of the invention.

FIG. 19 illustrates a screenshot of an IM Chat screen in accordance with the user interface of the invention.

FIG. 20A shows the tab information associated with the AIM portal.

FIG. 20B shows tab information associated with the Yahoo portal.

FIG. 20C illustrates the tab information associated with the MSN portal.

FIG. 21A illustrates community-specific presence icons for the AIM portal related to conversation, offline, and online status.

FIG. 21B illustrates community-specific presence icons for the MSN portal, related to Online, Offline, Busy, Be Right Back, Away, On The Phone, Out To Lunch, Blocked, and Mobile.

FIG. 21C illustrates community-specific presence icons for the Yahoo portal related to Available, Away, Idle, Mobile, and Offline.

FIG. 22A shows the chat icon for an AIM portal.

FIG. 22B shows the chat icon for the Yahoo portal.

FIG. 22C shows the chat icon for the MSN portal.

FIG. 23A shows a screenshot of the option menu for the AIM portal.

FIG. 23B shows a screenshot of the option menu for the Yahoo portal.

FIG. 23C shows a screenshot of the option menu for the MSN portal.

FIG. 23D shows the New Buddy popup for the AIM portal.

FIG. 23E shows the New Buddy popup for the Yahoo portal.

FIG. 23F shows the New Buddy popup for the MSN portal.

FIG. 23G shows the New Buddy error popup for the AIM portal.

FIG. 23H shows the New Buddy error popup for the Yahoo portal.

FIG. 231 shows the New Buddy error popup for the MSN portal.

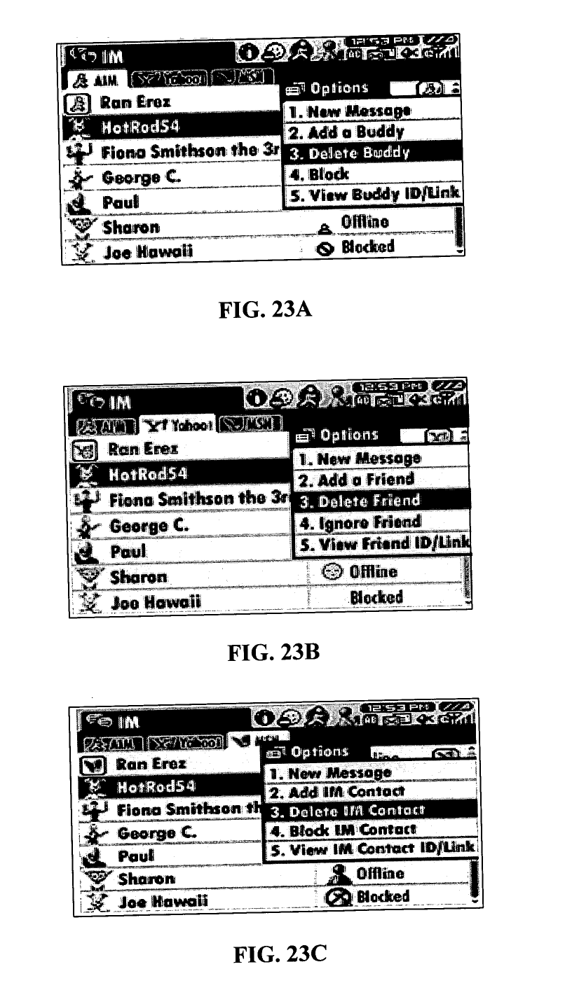

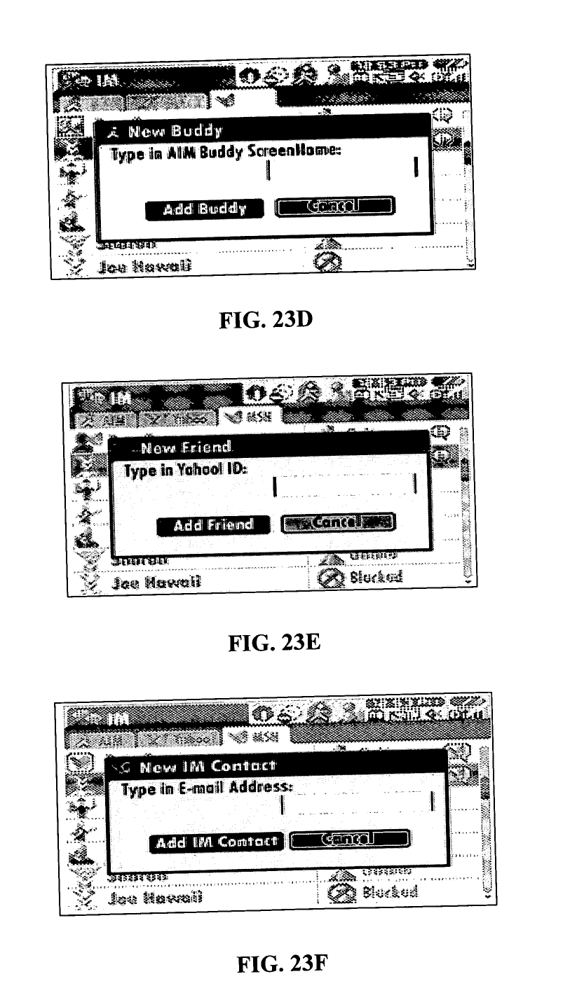

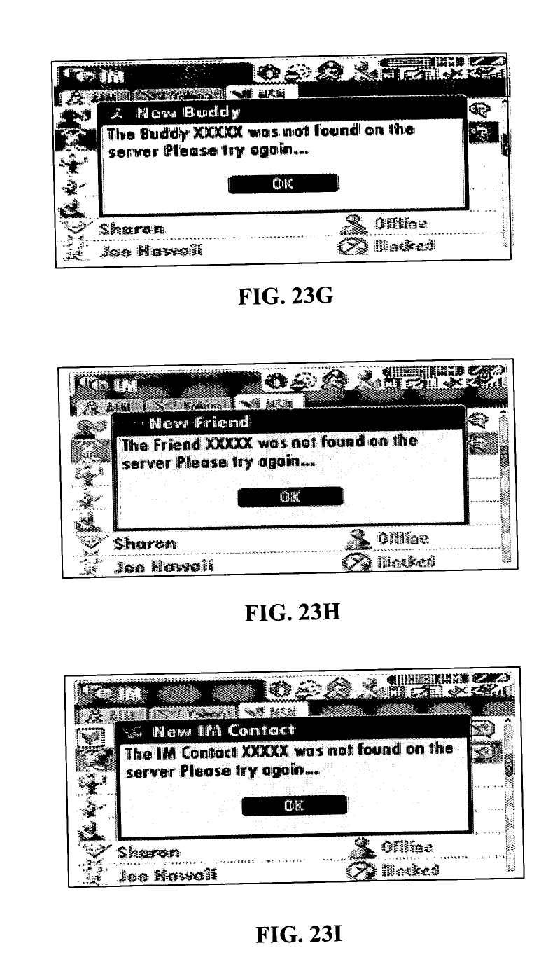

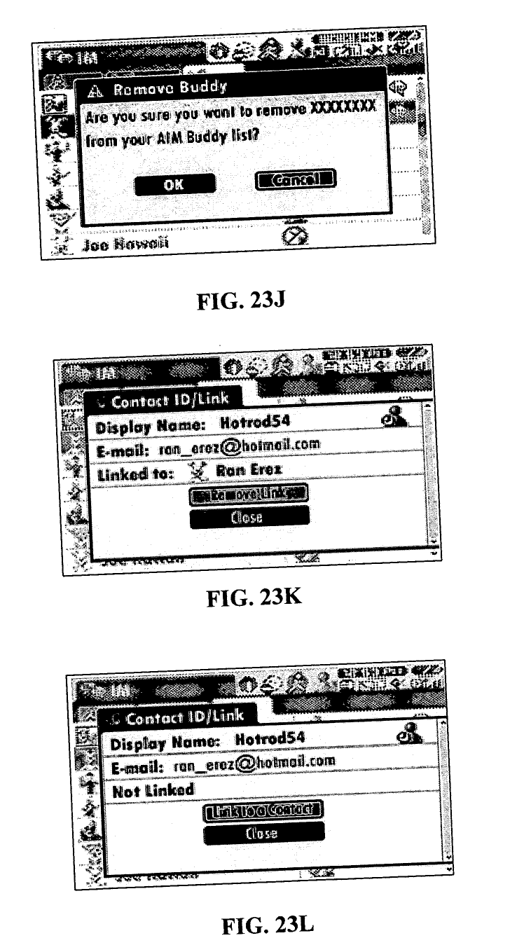

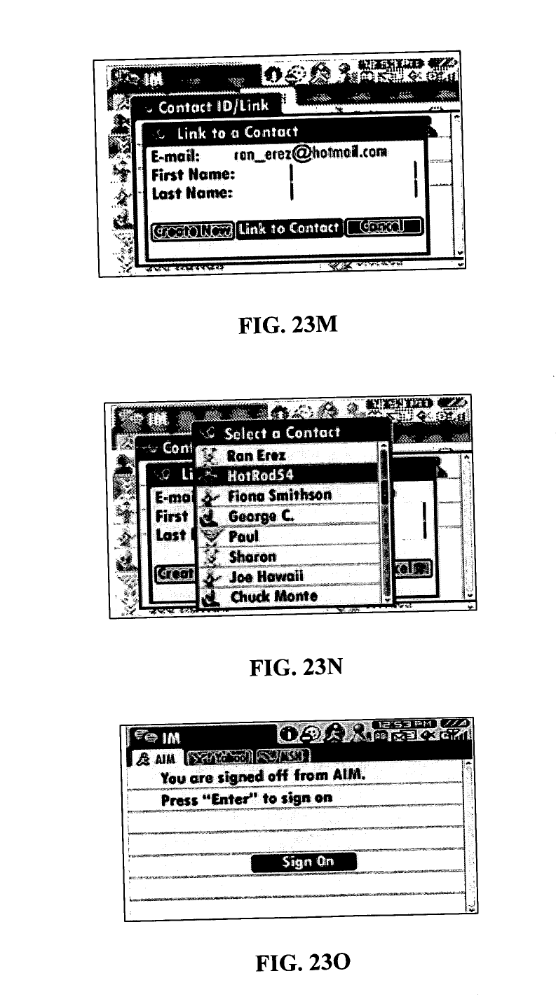

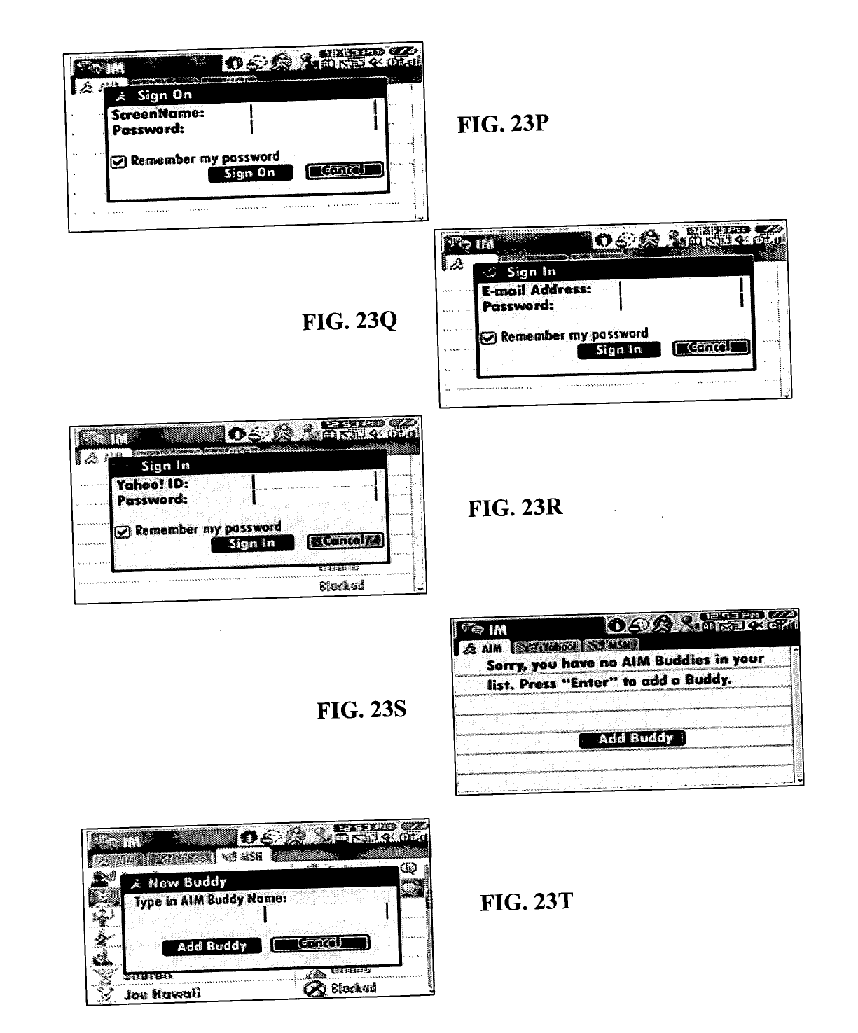

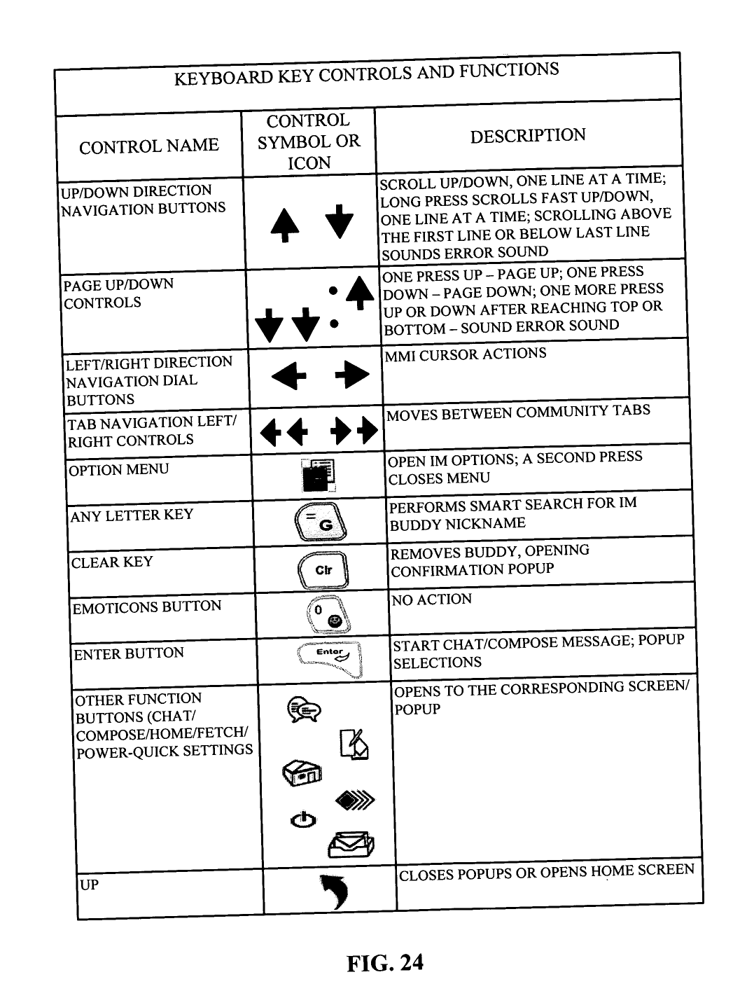

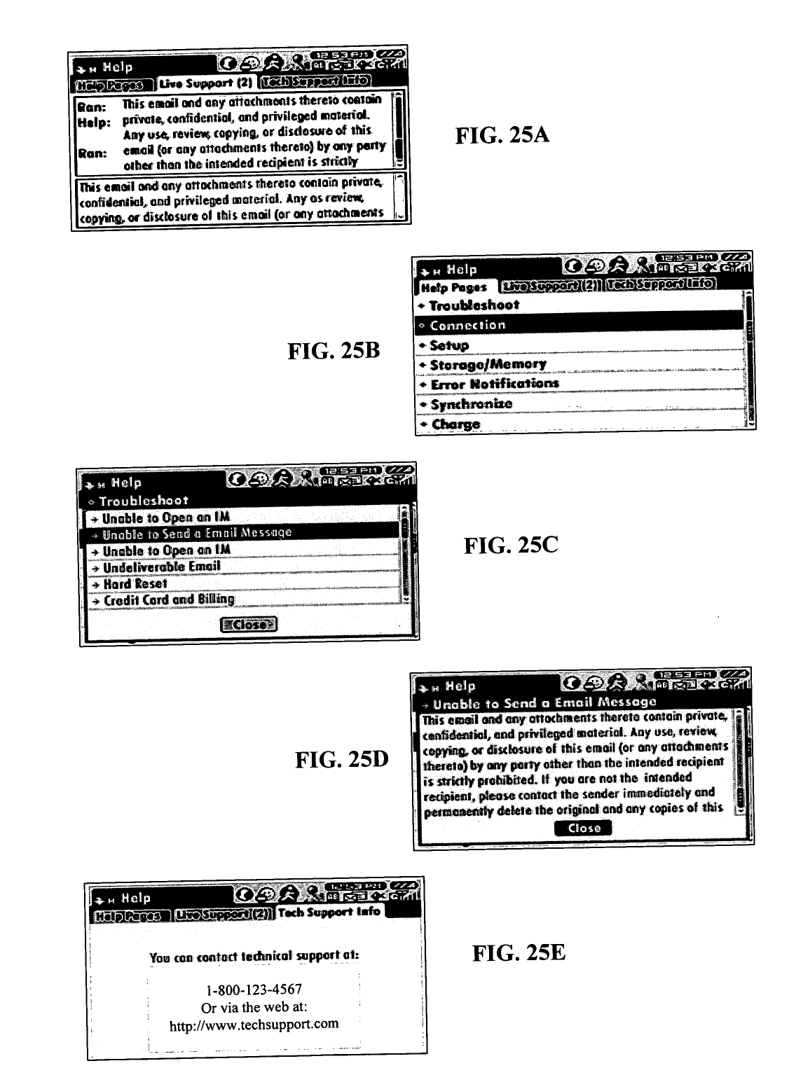

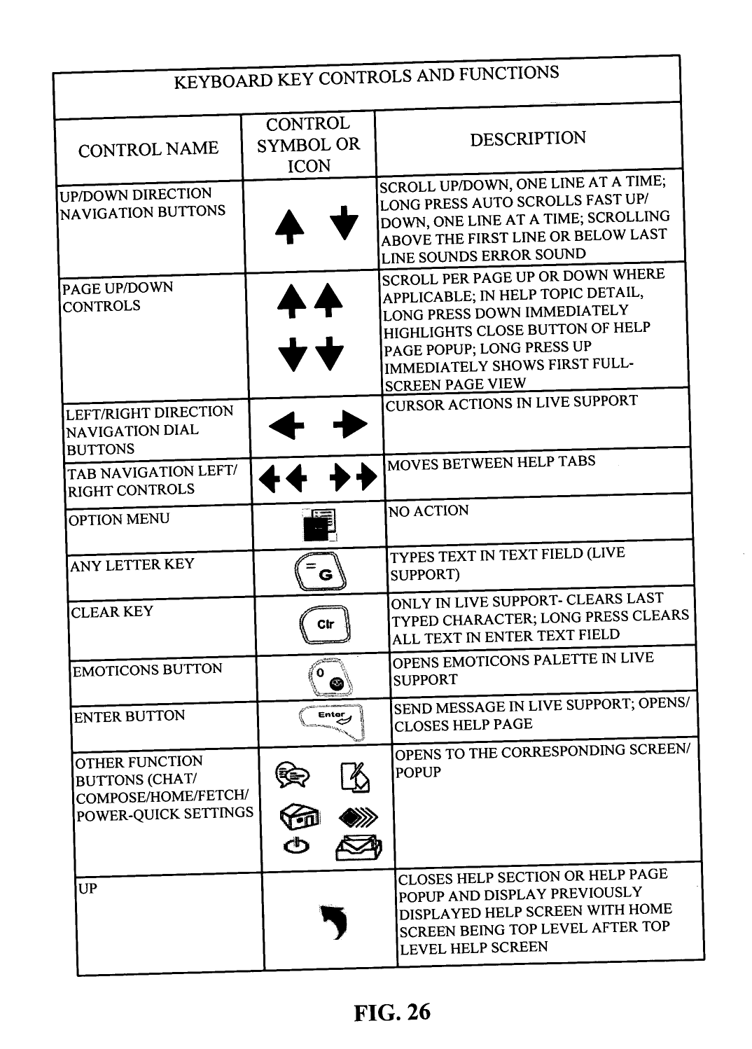

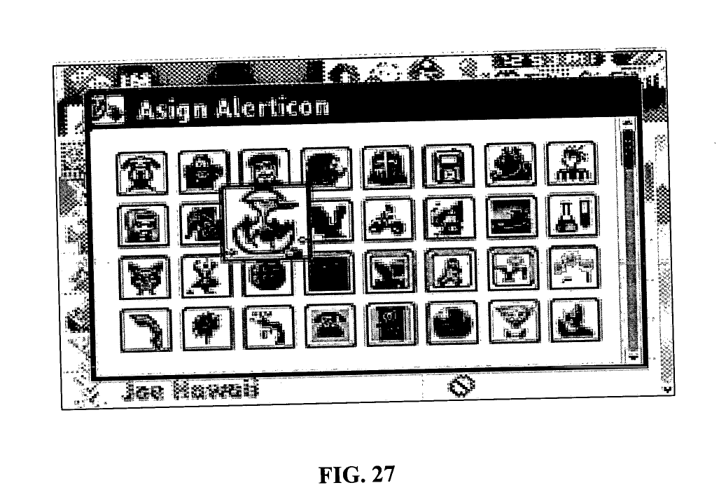

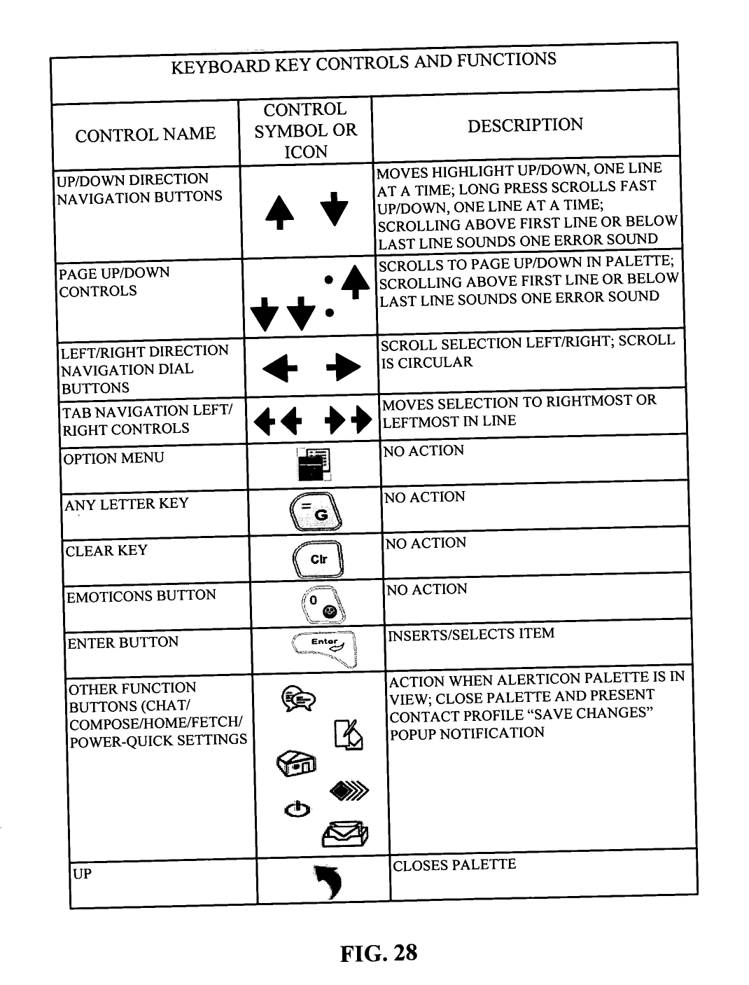

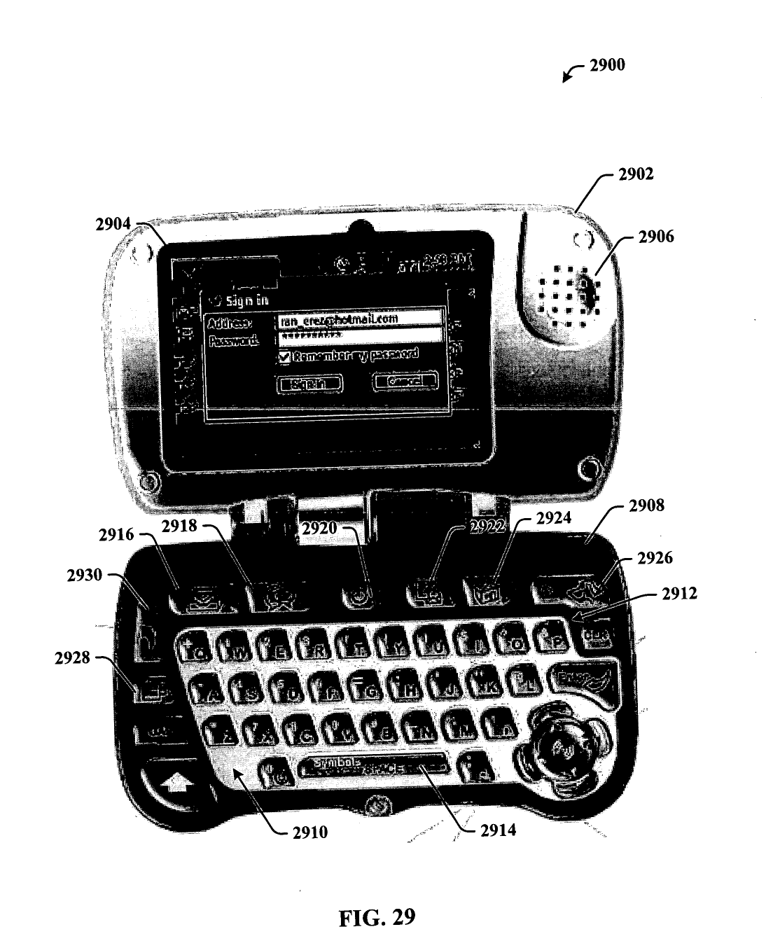

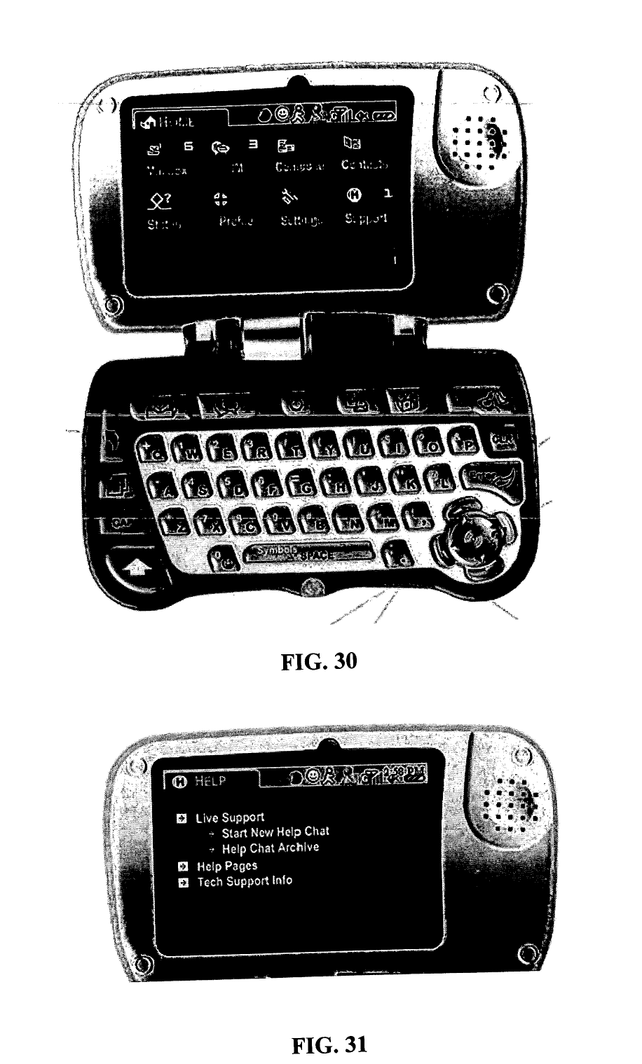

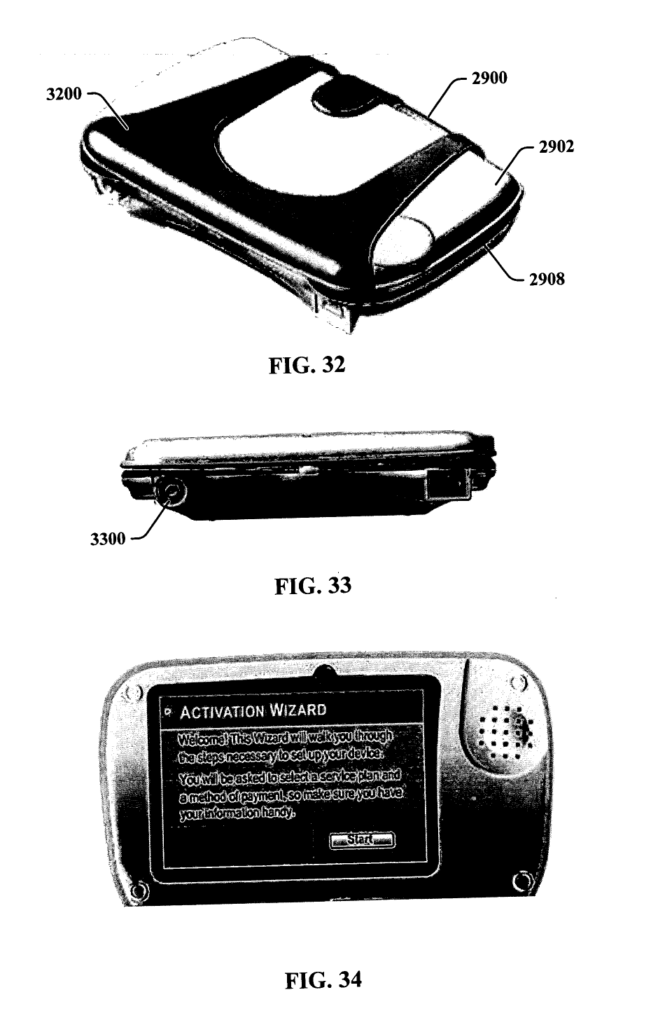

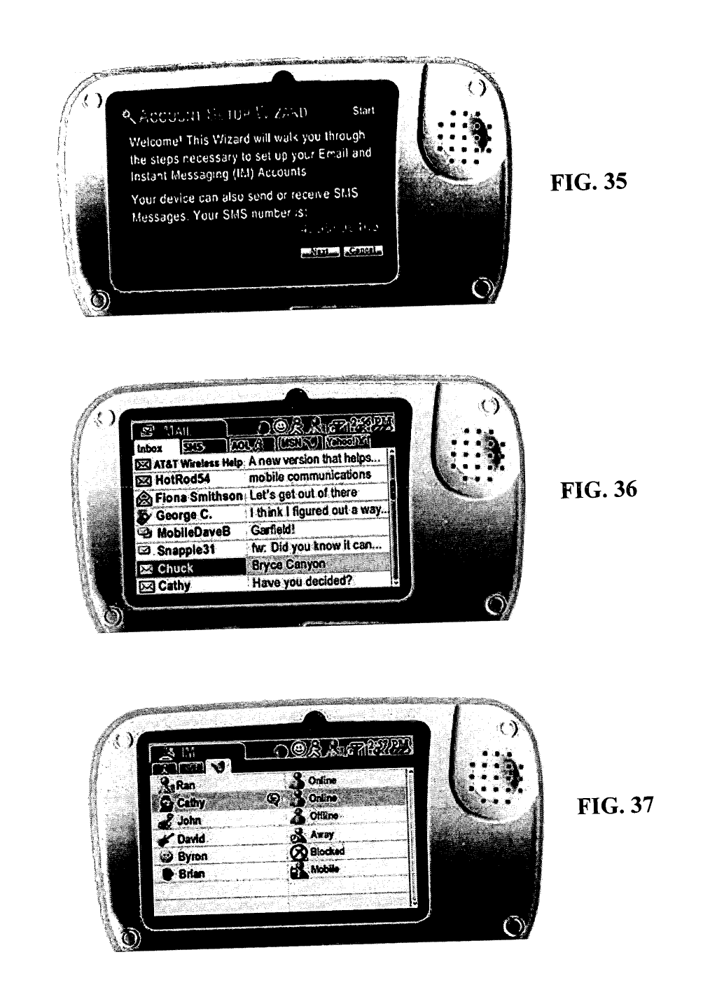

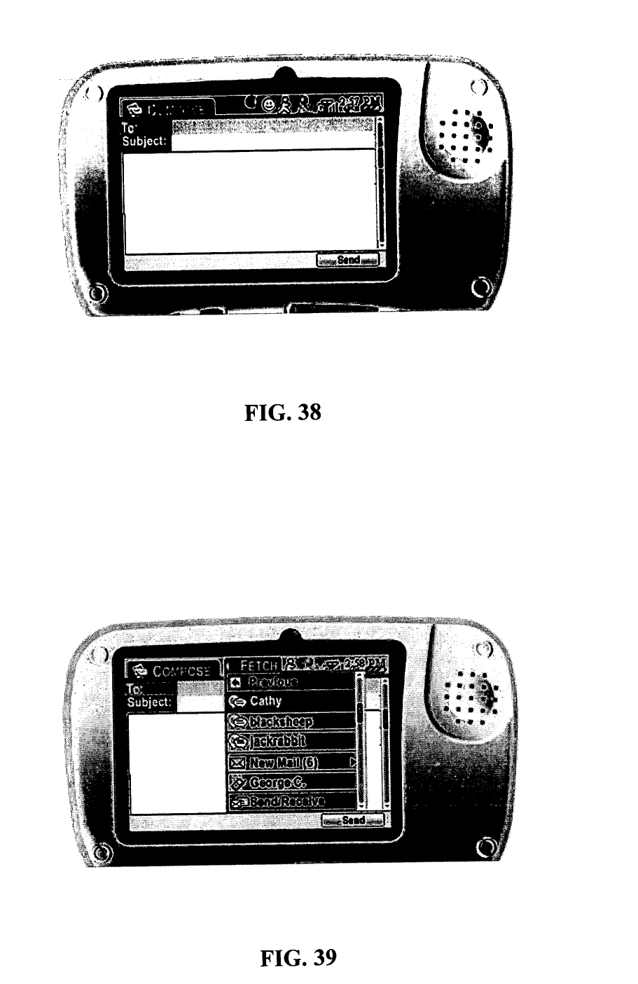

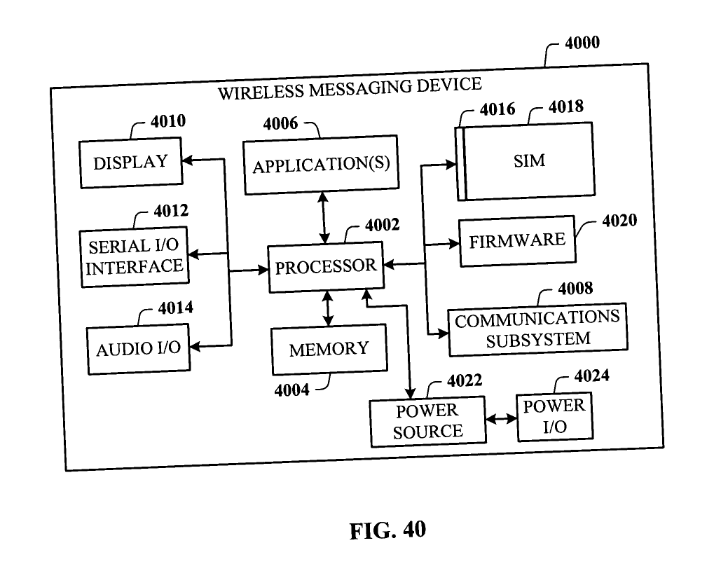

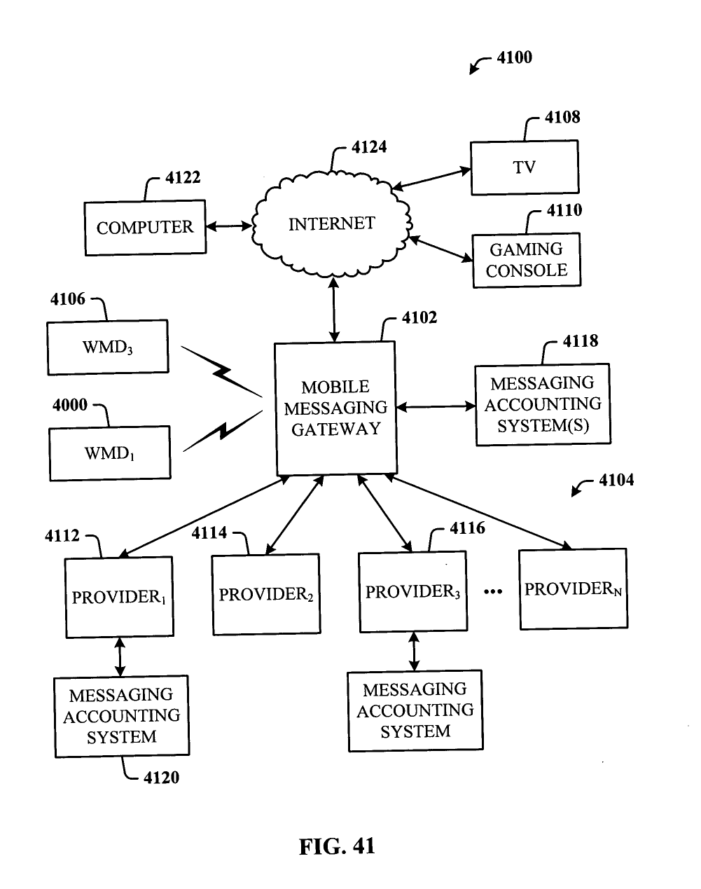

FIG. 23J illustrates a confirmation popup for the user to confirm and invoke the Delete function.

FIG. 23K shows the MSN profile card for a “Remove Link” option.

FIG. 23L shows the MSN profile card for a “Link to a Contact” option.

FIG. 23M illustrates a popup presented when a “Link to a Contact” option is selected.

FIG. 23N illustrates a window presented that allows a user to select a contact when selecting the Link-to-Contact button in the window of FIG. 23M.

FIG. 23O illustrates a screenshot of a message presented when the user is not logged in.

FIG. 23P illustrates a screenshot of a Sign-On popup window for an AIM user that opens when presses Enter in the sign-in popup sequence.

FIG. 23Q illustrates a screenshot of a Sign-in popup window for an MSN user that opens when presses Enter in the sign-in popup sequence.

FIG. 23R illustrates a screenshot of a Sign-In popup window for a Yahoo! user that opens when presses Enter in the sign-in popup sequence.

FIG. 23S illustrates a screenshot of an AIM window that open when no buddies are on the user buddy list.

FIG. 23T illustrates a screenshot of a New Buddy popup window that opens to add an AIM buddy.

FIG. 24 illustrates a table of some keyboard key controls and functions of the present invention.

FIG. 25A illustrates a Live Support screen in accordance with the help tool of the present invention.

FIG. 25B illustrates a Help index list screen.

FIG. 25C illustrates a Help Sub-Topics screen.

FIG. 25D illustrates a Help Topic Detail popup screen.

FIG. 25E illustrates a Technical Support Information screen.

FIG. 26 illustrates a table of keyboard controls and functions associated with interaction with the Help tool of the invention.

FIG. 27 illustrates an Alerticon palette that can be accessed to associate icons with contact profile, in accordance with the invention.

FIG. 28 illustrates a table of keyboard key controls and functions provided associated with interaction of the Alerticon palette of the invention.

FIG. 29 illustrates a front open view of another implementation of a WMD in accordance with the invention.

FIG. 30 illustrates the device where the user interface shows one version of a Home page in accordance with the invention.

FIG. 31 illustrates one version of a live support Help screen in accordance with the invention.

FIG. 32 illustrates a generally top view isometric of the WMD of FIG. 29 in a closed position.

FIG. 33 illustrates a front view of the device in a closed position.

FIG. 34 illustrates an activation wizard screen for initiating activation in accordance with the invention.

FIG. 35 illustrates one version of an account setup wizard screen in accordance with the invention.

FIG. 36 illustrates one version of a mail inbox interface screen in accordance with the invention.

FIG. 37 illustrates one version of an instant messaging status screen for an MSN portal in accordance with the invention.

FIG. 38 illustrates one version of a compose screen in accordance with the invention.

FIG. 39 illustrates one version of a fetch popup screen in accordance with the invention.

FIG. 40 illustrates a block diagram of a WMD in accordance with the invention.

FIG. 41 illustrates a block diagram of a wireless messaging system (WMS) that uses a mobile messaging gateway server in accordance with the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the invention. It may be evident to one skilled in the relevant art, however, that the invention may be practiced without these specific details. In some instances, well-known structures and functions have not been shown or described in detail to avoid unnecessarily obscuring the description of various embodiments of the invention. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running in a mobile computing device and the mobile computing device can be a component. One or more components may reside within a process and/or thread of execution and a component may be localized on one computer and/or distributed between two or more computers.

The terms “screen,” “screenshot,” “window,” “web page,” and “page” are generally used interchangeably herein. The pages presented by a computing device or mobile terminal device can be implemented using, for example, WML (Wireless Markup Language), HTML (HyperText Markup Language), XHTML (Extensible HTML), and/or XML (Extensible Markup Language). The page or screens are stored and/or transmitted as display descriptions, as graphical user interfaces, or by other methods of depicting information on a display. A display description refers to any methodology of presenting information in any of the above-mentioned formats, or formats that are known to one skilled in the relevant art. This includes, e-mail or character-based formats, algorithm-based formats (e.g., vector generated), and matrix or bit-mapped formats.

Messaging-Centric Wireless Device

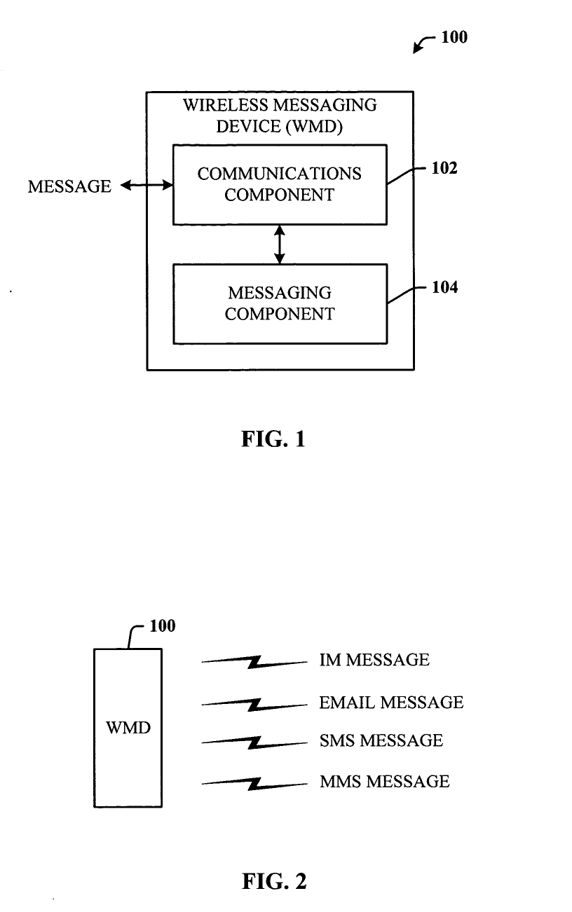

Referring now to FIG. 1, there is illustrated a wireless messaging device (WMD) 100 that facilitates always-on message processing in accordance with the invention. The WMD 100 includes a communications component 102 that facilitates wireless communications with an always-on messaging communications system. In a receive mode, the communications component 102 receives a message (MESSAGE) and forwards the message to a messaging component 104 for processing and presentation to a WMD user. In this illustration, the messaging component 104 includes all the software and hardware needed to process and present the message to the user. This can include a man-machine interface (MMI) via which the user can interact to perceive the received message and/or to input further messages for transmission from the WMD 100 back into the always-on communication system. The modes of perception by the user can be visual by presentation of the message content on a display, audio by audio output signals that represent the content of the message, and touch by Braille signals presented on a Braille display, or any combination thereof. Similarly, the mode of message input can be via keyboard (or touch screen) that facilitates visual presentation of the message content on the display, audio input by voicing words that are interpreted and converted into message content, and touch, such that a keyboard, for example, includes Braille inputs for a user who cannot perceive information visually and/or audibly, or any combination thereof.

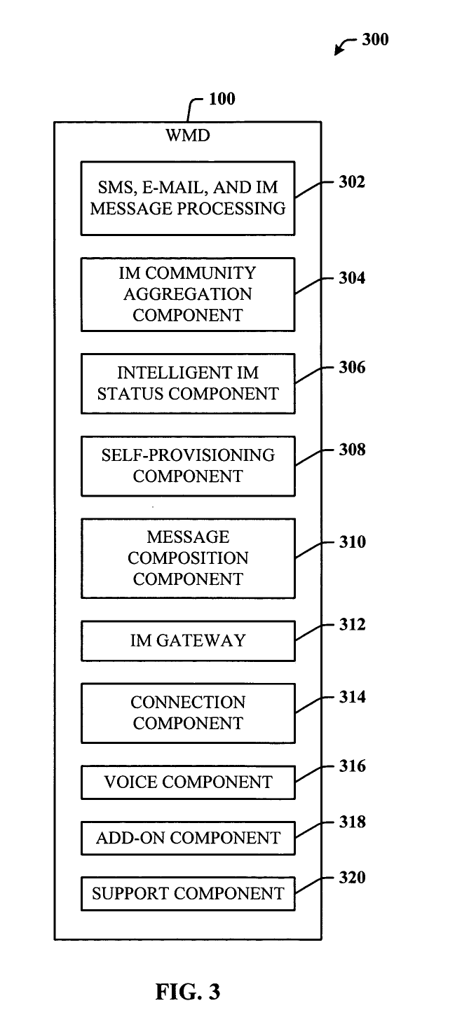

Referring now to FIG. 2, there is illustrated a general diagram of the types of messages that can be communicated with the WMD 100 of the invention. The WMD 100 can communicate at least Instant Messaging (IM) messages, e-mail messages and SMS (Short Message Service) messages. SMS is a wireless service available on digital mobile networks that enables the transmission of text messages between mobile phones and other systems such as electronic mail, paging and voice mail. Up to 160 characters can be sent and received through the network operator's message system to the mobile phone. SMS is an alternative to paging services, and can be used to provide reminder services, stock and currency quotes, airline schedules, and account information. SMS is a store and forward service where short messages are not sent directly from sender to recipient, but rather via an SMS Center.

Each mobile telephone network that supports SMS has one or more messaging centers to handle and manage the short messages. SMS features confirmation of message delivery, which means that unlike paging, users do not simply send a short message and hope that it gets delivered. Instead the sender of the short message can receive a return message back notifying them whether the short message has been delivered or not. Short messages can be sent and received simultaneously with GSM (Global System for Mobile Communications) voice, data and fax calls. This is possible because whereas voice, data and fax calls take over a dedicated radio channel for the duration of the call, short messages travel over and above the radio channel using the out-of band signaling path. As such, users of SMS rarely, if ever, get a busy or engaged signal as they would get during peak network usage times.

In another implementation, it is within contemplation that messaging communicated by the WMD 100 can include MMS (Multimedia Messaging Service) messages that include pictures, video clips, cartoons and other graphic information.

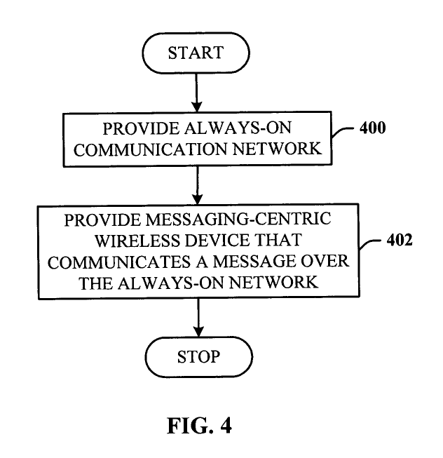

Referring now to FIG. 3, there is illustrated some of the capabilities 300 provided in the WMD 100 of the invention. The invention includes the messaging-centric wireless device 100 that communicates always-on messaging for at least e-mail, SMS messages, and IM messages. One of the core capabilities of the device is to support always-on mobile IM, including IM status information. The device/service can include some or all of the following additional features. A message processing component 302 that facilitates the capability to send and receive SMS messages via SMS or non-SMS provider networks, send and receive e-mail messages from multiple e-mail or non-e-mail provider accounts, send and receive IM messages from multiple e-mail accounts and, send and receive IM messages from multiple IM providers. An IM community aggregation component 304 facilitates interfacing with one or more major messaging entities in the marketplace (e.g., AIM™ by America Online, Inc., Y! ™ by Yahoo! Inc., and MSN™ by Microsoft Corporation).

Although the following description refers to three common providers that provide services related to message communications, be it e-mail, an IM message, or SMS message, for example, this should not be construed in any way as limiting the present invention. It is within contemplation of the subject invention that any number of different providers can be accommodated by employing one or more of the disclosed novel aspects. By way of illustration but not by limitation, the following description uses different terms to distinguish different providers, e.g., the term Buddy is associated with AIM, IM Contact to be associated with MSN, and Friend to be associated with Yahoo! An intelligent IM status component 306 provides to a user of the WMD 100 status information of other remote users who are online. This can include other users of the same community or of other communities. A self-provisioning component 308 facilitates the automatic provisioning of the WMD 100 when a user initially purchases the WMD 100 and subsequently, the provisioning (or de-provisioning) of additional messaging providers thereafter, if all were not provisioned initially.

A message composition component 310 facilitates the capability to compose messages without having to indicate dependent aspects of the message such as delivery bearer, which is the mode or communications path employed to communicate the messaging information (e.g., e-mail, SMS, MMS, and so on). If the message means is e-mail, as determined by entry of an e-mail address, the bearer is selected as an e-mail network that utilizes, for example, SMTP (Simple Mail Transfer Protocol). If the message service is selected as a telephone number, the bearer can be SMS, MMS, EMS (Enhanced Message Service), or similar technologies. The architecture of the subject invention facilitates the selection of multiple bearers depending on the recipient clients employed to receive the message(s). For example, if the source client is sending a message to two recipients, one of which is an e-mail client and the other a messaging service client, the message being sent will be processed into the bearer for e-mail and the bearer for the appropriate messaging service.

An IM gateway component 312 (internal to the WMD 100) facilitates the aggregation of different instant messaging and/or e-mail technologies into the WMD 100 the single device 100 by allowing access to different messaging technology providers. A connection component 314 facilitates the connection to the always-on network, and/or a dedicated network environment PDP (Packet Data Protocol)/APN (Access Point Name). Additionally, an always-on connection can be maintained either through a sustained wireless data connection or through buffered/mediated services that use out-of-band signaling to initiate a PDP context.

A voice component 316 facilitates the capability to include voice signals as the message or in combination with the message. An add-on component 318 facilitates the capability to include other or future data services or technologies as they evolve by providing an interface component or module to which these technologies can be manufactured for implementation into the WMD 100. A support component 320 facilitates interaction with support information to resolve one or more problems that can be encountered during any operation of the WMD 100, to include, but not limited to provisioning, account setup, billing, device hardware and software problems, and so on. The support component 320 facilitates interaction with live support personnel and/or stored support database information, whether local to the WMD 100 or remote therefrom. Updates to local support information can be downloaded OTA when updates thereto become available. The user can be made aware of any software updates to the WMD 100 automatically by notification or by manually accessing a website that posts such software updates. Software updates include not only support information, but also device drivers, firmware updates, user interface updates, and application updates provided to more efficiently operate and interact with the WMD 100.

Referring now to FIG. 4, there is illustrated a flow chart of one methodology for providing a message-centric system in accordance with the invention. While, for purposes of simplicity of explanation, the one or more methodologies shown herein, e.g., in the form of a flow chart, are shown and described as a series of acts, it is to be understood and appreciated that the invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

At 400, an always-on network is provided that facilitates wireless communications to the WMD. At 402, the WMD connects to the network to communicate messages, e.g., IM messages, SMS messages, and/or e-mail messages.

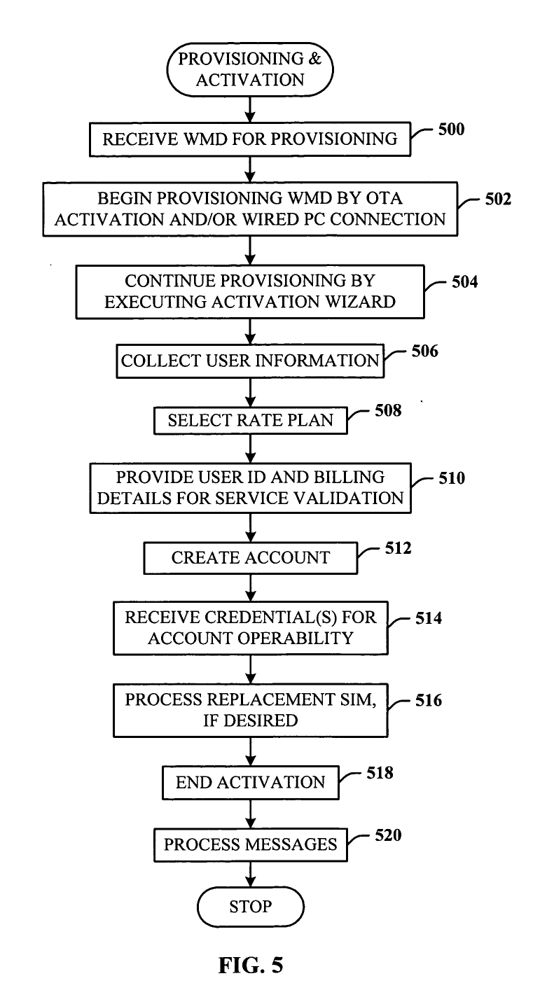

Referring now to FIG. 5, there is illustrated a methodology of provisioning and activation of the WMD in accordance with the invention. The user can activate their data service from the WMD without having to use a desktop computer or place a call into a service representative. The user can, however, choose to setup the WMD via a telephone or desktop. Following successful service activation, the user is then able to setup IM and e-mail accounts from the device without going to their computer.

In support thereof, at 500, the user receives the WMD for provisioning. At 502, the user can begin provisioning the WMD by over-the-air (OTA) activation and/or a wired/wireless PC connection. At 504, the user is directed to an Activation Wizard (AW) upon powering on an unprovisioned device, and continues provisioning via the AW using form fields. At 506, the AW prompts the user for user information. Initially, the AW directs the user to select a data only rate plan, as indicated at 508. Once activation is complete, the user/customer runs a Messaging Wizard to set up the number of IM communities desired for connectivity. If the user wants access to add/delete/change their premium portal(s) the action originates from the Messaging Wizard.

At 510, the AW provides the user identification and billing details to an appropriate service for validation. Once activation is complete, the user can be sent an e-mail with a URL that directs the customer to a branded web page, where a customer will be prompted to create an account, as indicated at 512. The account username is the customer's primary e-mail address. The account password can be the Customer SSAN (Social Security Account Number) or PIN (Personal Identification Number), depending on what was used to create the account. At 514, the user receives a notification that their service has been activated or denied. When activated, credentials are downloaded into the WMD for account operability, as indicated at 514.

Upon first device activation failure, the user will be sent an appropriate error message and given the opportunity to correct the point of failure or contact a customer care support facility. Upon second or subsequent device activation failures the user can also be prompted to contact the customer care support facility.

The AW successfully completes prior to invocation of the Messaging Wizard. A welcome message can include a new MSISDN (Mobile Station ISDN number). Over-the-air provisioning of the MSISDN number is sent to the WMD and stored in phone settings, e.g., under a setting called “My Number”. Following the acceptance of the MSISDN by the WMD, a new APN is sent along with any other lower level device settings. All settings that the user needs to access are saved to a Settings Application that is described below. The user can pay with a credit card. The AW will collect the user's acceptance of the Terms & Conditions provided in the purchased item package. If the user is an existing 2G or 2.5G customer, they can request the continued use of a current phone number on the WMD. If the user is an existing customer, a line of service can be added to their existing 2.5G postpaid account. Billing for data transport begins upon successful messaging account configuration.

At 516, replacement SIMs can be processed or pre-provisioned, prior to receipt by end customer. Replacement WMDs can be shipped preconfigured with existing account information following contacting of the customer care facility. The user remains in the AW until service activation is complete or have been denied service and referred to Customer Care for resolution. At this point activation ends, as indicated at 518. At 520, the user can then process account messages.

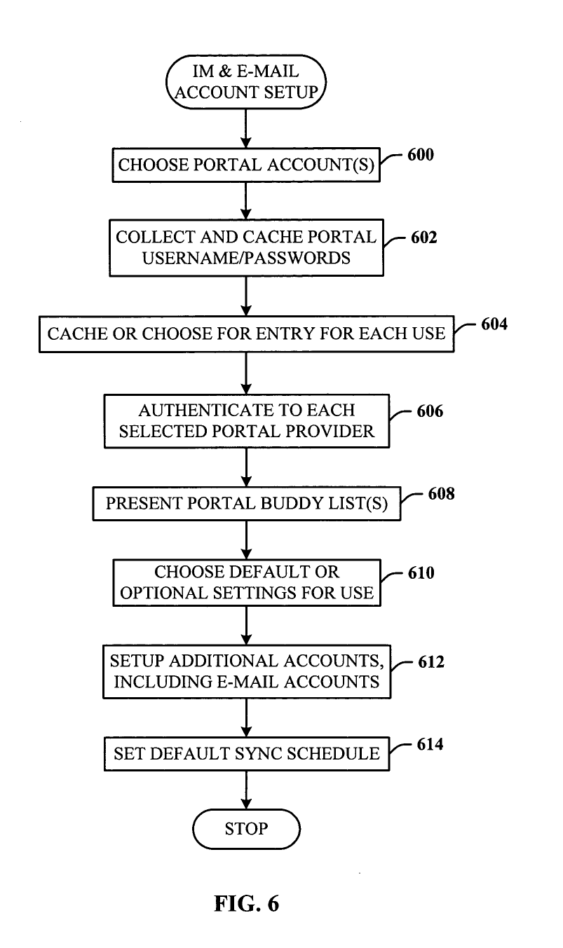

Referring now to FIG. 6, there is illustrated a methodology for IM and e-mail account setup according to one aspect of the invention. IM and e-mail account setup is driven by the Messaging Wizard. At 600, the Messaging Wizard prompts the user to set up an included premium portal account from a set of subscribed portal partners. The end user can use the Messaging Wizard to collect and cache the user's IM and/or E-mail username/s and password/s for each account being configured for use. At 602, the IM and e-mail usernames and passwords are security cached for automatic use. At 604, the user can choose whether to used cache credentials or force manual entry for each use if they wish not to cache their credentials on the WMD.

After completion of the Messaging Wizard, each properly configured premium portal messaging account attempts to be authenticated with the associated portal provider, as indicated at 606. At 608, each configured account user's buddy list is visible via the device client subject to premium portal limitations. At 610, the user is provided the option to accept default settings or select an option from a limited set of key criteria. Default settings include the status given to user when device is closed, status given to user when mobile, and deletion of chats after end of chat session, for example. This list is not exhaustive. Advanced settings can be accessed at a later time from the Settings Application under Homepage Applications, which is described below. Upon completion of first portal account setup the Messaging Wizard offers the user the ability to set up additional accounts, as indicated at 612.

After completion of premium portal setups, the Messaging Wizard offers the user the ability to set up access to ISP/POP3 accounts. The Messaging Wizard offers the user the ability to select a POP3 e-mail provider from a drop down menu list. This list includes a number of ISP e-mail providers plus an ‘Other’ option to allow manual server addressing. Upon completion of setting up the premium portals and ISP's, the Messaging Wizard provides the customer with a summary of all selections. The Messaging Wizard can automatically configure the server side addressing.

The Messaging Wizard will request the user's username and password for each configured messaging account, which can be cached on the device in a secure location. Alternatively, the information need not be secured. This will allow for the background synchronization (or “sync”) to occur. As indicated previously, the user can opt not to cache credentials on the device. At 614, a default sync schedule can be applied upon each messaging account creation. A set of advanced setup features can be accessed from a Settings Application, which is described below. The Messaging Wizard offers the user the capability to add additional POP3 e-mail accounts, up to a predetermined number, e.g., five separate e-mail accounts.

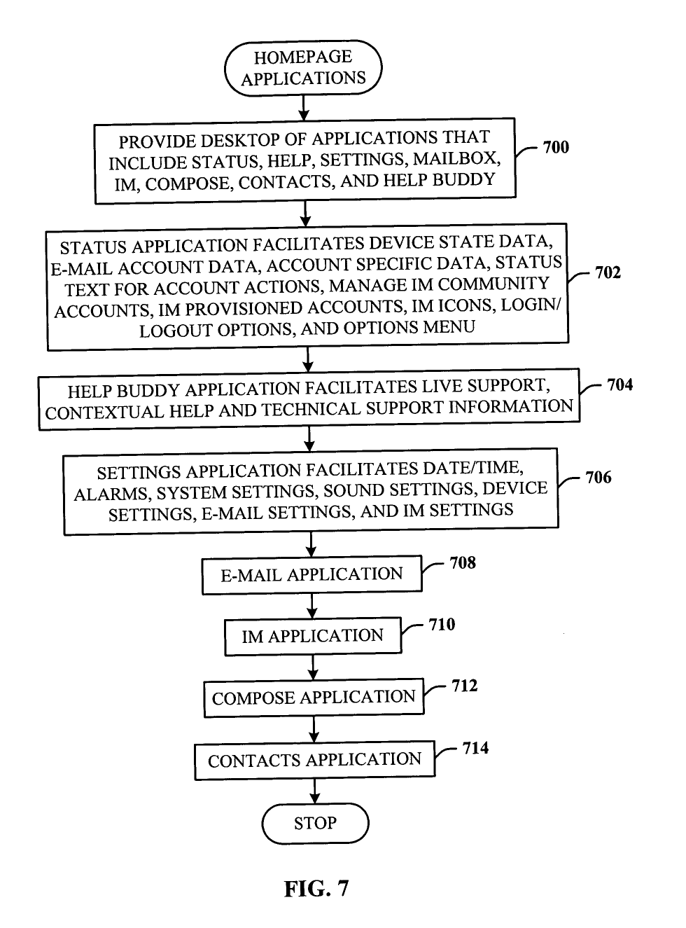

Referring now to FIG. 7, there is illustrated a methodology of providing a homepage interface for the WMD of the invention. At 700, the homepage interface is facilitated by a homepage application that includes the following applications represented further by unique icons and tiles: Status, Help, Settings, Mailbox, IM, Compose, Contacts and Help Buddy. At 702, the Status application provides a user with updated device state information for both e-mail and IM services, and allows the user to change the display name. The user can acquire information on e-mail accounts, and access this information via a tabbed and options menu format. This information can include account specific information and functions such as initiating a send/receive (Sync) request via the Options menu, view account details (e.g., last successful Sync, and Sync schedule), add New account, remove existing account, access the to Settings application, status text for account actions, date of last Sync, success, connecting, sending and deleting messages, retrieving new messages, notifications for no network coverage and no e-mail server response, authentication on e-mail server failed, and disconnecting.

The user is provided the capability to acquire/manage information specific to their IM Community accounts. Access to this information is provided in a tabbed and options menu format, and includes IM Status TAB. Here users are provided a general status view of all provisioned IM accounts. In addition to the status of the provisioned IM accounts the status table includes global presence and a presence status value for when the device is closed. With global presence, the user has the option to change the status of all IM Communities. Global presence status options reflect only those recognized by all IM Communities. The default global presence is the device is closed. When the unit is in the flipped closed state, the Status globally sets all IM Communities to the selected “Status When Closed” setting.

With respect to IM Community specific icons, all presence states and strings displayed/managed via the Status application confirm the guidelines provided by the IM Communities. The Options menu includes a “login/logout” option. Upon selection, the user is prompted for account credentials. Invalid account details returns an error message and requests the user to reenter account information. IM Community branding/icons can be shown during login. The Options menu for each IM Community in the Status Application includes change status, sign-in/sign-out, activate new community, and access to the Settings application.

At 704, the Help Buddy application provides the user with access to the following Chat Support services: live support with a care representatives via IM-based chat interface; support during standard Tech Forum hours; attempts to access Help Buddy services off hours generates a message indicating chat support is currently closed but available at (open hours); the IM application providing access to Help Buddy will be independent of existing IM accounts. The user MSISDN is made available for support services. No login information is necessary. Conversation threads are displayed above the text input area of the application. Chat history is provided with the Help Buddy. Chat history can be e-mailed to the user by the support service personnel using.

Contextual help is presented in sub-folder format, and includes the following: troubleshooting, connection, setup, storage/memory, and error notification. Technical Support contact information can include a web address for online help and the phone number for support services.

At 706, the Settings application enables the user to manage several application/device functions, which include but are not limited to date/time (format), alarm settings, system settings, memory, battery, and storage for the available contacts. Sound settings include volume, mute, vibrate, and Alerticon sounds. Device settings can include font size, backlight, contrast, banner alert settings, and device reset. E-mail settings can include Sync schedule parameters (e.g., 15, 30, 45, 60, 24 minutes, 24 hours), account name, add/delete account, login credentials, e-mail server settings, and auto-login. IM Settings can include community settings, auto-login, login credentials, and presence settings.

At 708, an e-mail application is provided, and is described in more detail below. At 710, an IM application is provided and is described in more detail below. At 712, a Compose application is provided that allows a user the capability to create new e-mail and SMS messages. The e-mail and SMS application are described in more detail below. At 714, a Contacts application is provided that enables a user to manage address book/contacts. The Contacts application is described in more detail below.

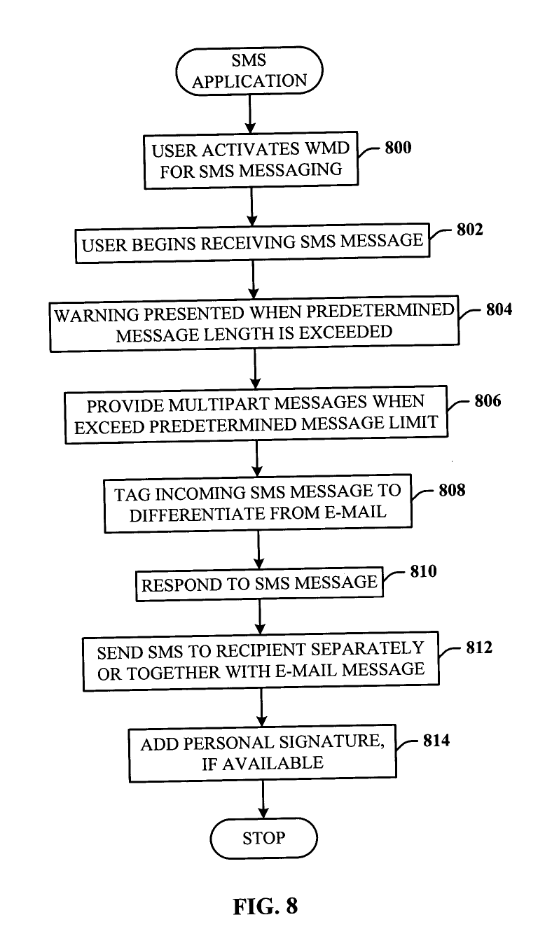

Referring now to FIG. 8, there is illustrated a methodology associated with an SMS application to provide SMS functionality in accordance with the invention. The SMS application provides support for long SMS messages. At 802, the user activates the WMD for SMS messaging. At 804, the user receives an audible warning if the SMS message exceeds a character limit of 160 characters. The SMS Community gateway automatically truncates SMS messages at 160 characters and provides multipart messaging, as indicated at 806. A counter shows the total number of characters used during message compose, as well as the number of concatenated messages.

At 808, incoming SMS messages are tagged for differentiation from other message types, e.g., e-mail. SMS storage capacity is pooled with e-mail storage capacity, which is limited to a predetermined number of pooled messages (e.g., 500 messages), after which FIFO (First In-First Out) rules apply. The user has the option to save a new SMS number to Contacts when sending/receiving to/from a new person. An SMS message is represented by a different icon than that of an e-mail. At 810, the user responds to the received SMS message with another SMS message, although this is not required. For example, the user can respond to the SMS message via an e-mail. At 812, the WMD includes the capability to allow the user to send the SMS message separately from an e-mail message or substantially simultaneously therewith. Additionally, at 814, a personal signature can be automatically applied when sending the SMS message via the SMS transport.

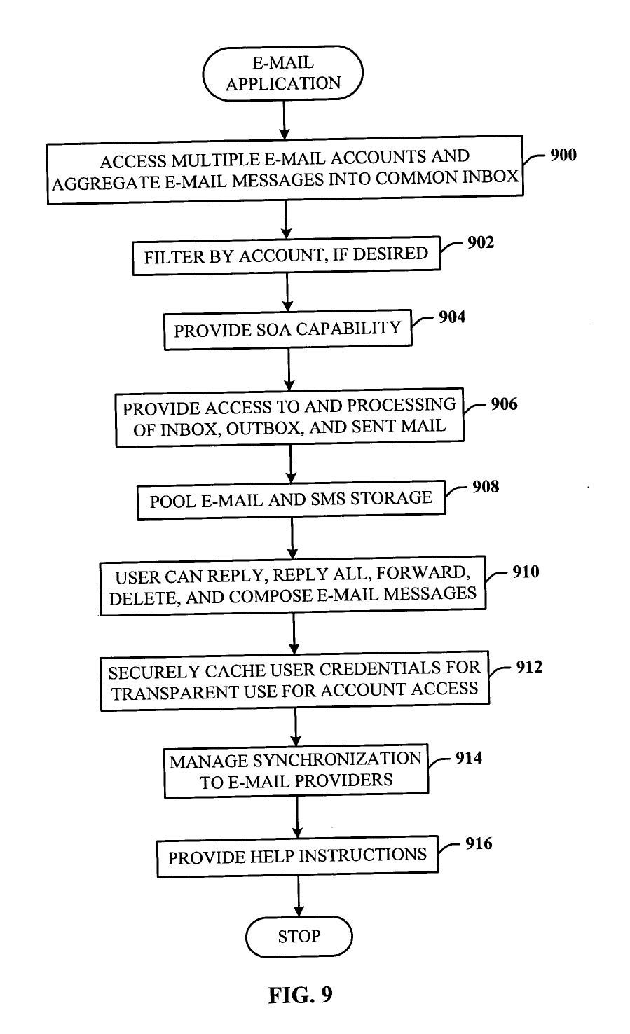

Referring now to FIG. 9, there is illustrated a methodology associated with an e-mail application that provides e-mail functionality in accordance with the invention. At 900, the application facilitates access to one or multiple e-mail accounts and aggregates e-mail messages into a common inbox. As indicated previously, the e-mail application supports POP3 ISP e-mail accounts, and portal e-mail access to common providers such as MSN Hotmail, Yahoo E-mail, and AOL E-mail. The service supports the capability to access multiple e-mail accounts, and the e-mail accounts are aggregated into one common Inbox. At 902, the e-mail software provides the capability to filter e-mail by account (e.g., unified Inbox Tab, AOL E-Mail Tab, MSN E-Mail Tab, Yahoo E-Mail Tab, and so on). At 904, the application provides to the user the capability to sidestep an e-mail account purge policy. For example, post to Saved On AOL (SOA) is a means of mitigating the purge policy in place for associated users. All opened e-mail is deleted from the users Inbox after seven days. Users have the choice of saving messages to the SOA folder to mitigate this.

At 906, the service can provide access to the Inbox, Outbox, and Sent Mail. Drafts get saved to Inbox but show as unsent e-mail. Outgoing e-mail waiting to be sent due to loss of coverage or inability to connect with server queue remains in the Outbox. The user can mark e-mail for SOA transfer. At 908, e-mail storage capacity is pooled with SMS storage capacity and is limited to 500 pooled messages. The e-mail application has a preset limit to each e-mail received. POP3 understands lines while IMAP4 is working with kilobytes. The WMD ensures that fifty lines or 3 Kb messages (whatever comes first) are downloaded. The user is able to request “More” data be sent if there is additional information in the original e-mail that is not displayed due to the message size limitation. E-mail messages contain at least the From: address, CC: address, the Date and Time received, and Subject.

At 910, the users can process e-mail according to Reply, Reply All, Forward, Delete and Compose e-mail messages from the WMD. The user also has the option when deleting e-mail to either delete the messages permanently from the server or clear from the WMD device. If cleared from the WMD, the mail is not resent from the server. If deleted from the device, then the e-mail is moved to a deleted e-mail folder on the server. Copies of the sent e-mail are copied to the server and placed in the appropriate “Sent” mail folder if the portal supports this feature. An e-mail that has not been read on the device is not marked as read on the server (ISP/POP3). An e-mail that has been read on the device is marked as read on the server. When replying to messages the originator e-mail address is auto-addressed in the “To:” field. Additional recipients can be added from the Contact list or manually entered. When replying to e-mails the original message is included, and RE: will precede the original subject.

When forwarding e-mail messages, the user enters at least one recipient. Additional recipients can be added from the Contact list or manually entered. When forwarding e-mail messages, the original message is included and “FW:” precedes the original subject. When replying to or forwarding an e-mail, the user's e-mail address is that of the account to which the e-mail was sent and the e-mail is routed via that account's server. A default user address for composing new e-mail is that of the first e-mail account provisioned or the user selected Default account. The user can change which provisioned e-mail account is set as the Default outgoing e-mail address in the Settings application. The user can change the outgoing e-mail address per message if desired through the Compose interface.

The user can change or manage user account information for premium portals and ISPs from the Settings application in the WMD device. In one implementation, at 912, the credentials (e.g., username and password) are cached securely and used to seamlessly access each e-mail account. In another implementation, the credentials are not cached in a secure manner. At 914, the user can manage synchronization to e-mail provider servers. The default setting for scheduled Sync is every sixty minutes. The user can pull e-mail on demand. E-mail synched to the device leaves a copy on the server. The user can customize the Sync schedule from a preset list of options (e.g., Minutes: 15, 30, 60; and Hours: 4 or 24; and Never).

At 916, basic Help instructions are provided. Help information is Index oriented. When a user accesses a POP3 e-mail account and the server is unavailable, an error message is passed to the user that describes the error (e.g., Error: Yahoo server is unavailable). When a user accesses e-mail and their account credentials are incorrect, (e.g., their password has been changed) an error message is passed to the user that describes the error (e.g., Error: Incorrect Password). When an incorrect password error is encountered, the user is automatically presented with a notification and the re-enter Username and Password form fields.

When a user presses Send, a connection is automatically established with the e-mail server, and the message is then sent immediately, unless connectivity issues exist. When sending e-mail and connected to the e-mail server, the software client queries for any new e-mail. Scheduled Sync or sending of an e-mail does not interfere with an IM session or slow down general use of the WMD device. Users are provided the capability to sort messages under any tab by Sender or Date/Time stamp. An e-mail client provides the user the capability to filter e-mail in a tabbed format (e.g., Common Inbox, Premium Portals, SMS, and Search). A user is allowed to perform a search of all device resident messages.

SMS messages are received into the single Inbox, and assigned a different indicator to differentiate the message type from e-mails, for example. When composing a message the user can send to both e-mail accounts and SMS recipients in a single TO: list. When Composing/Replying/Forwarding a message exclusively to SMS (numeric) contacts, the address shown is the user's MSISDN. The user can also send an SMS message from the user's e-mail account. Indication is also provided when an attachment was part of the original message. Additionally, an indication is provided when text was reformatted from HTML, RTF, Java, WML, etc. If the user tries to permanently delete a message that has non-viewable content (e.g., Attachment), then a specific error message can be presented to the user.

A branded auto signature can be appended that conveys that the message is being sent from this WMD device. The user is provided the capability to disable the branded auto signature within the Settings application. The user also is provided the option to save a new e-mail address to Contact when sending to a recipient not already contained in the device contact list.

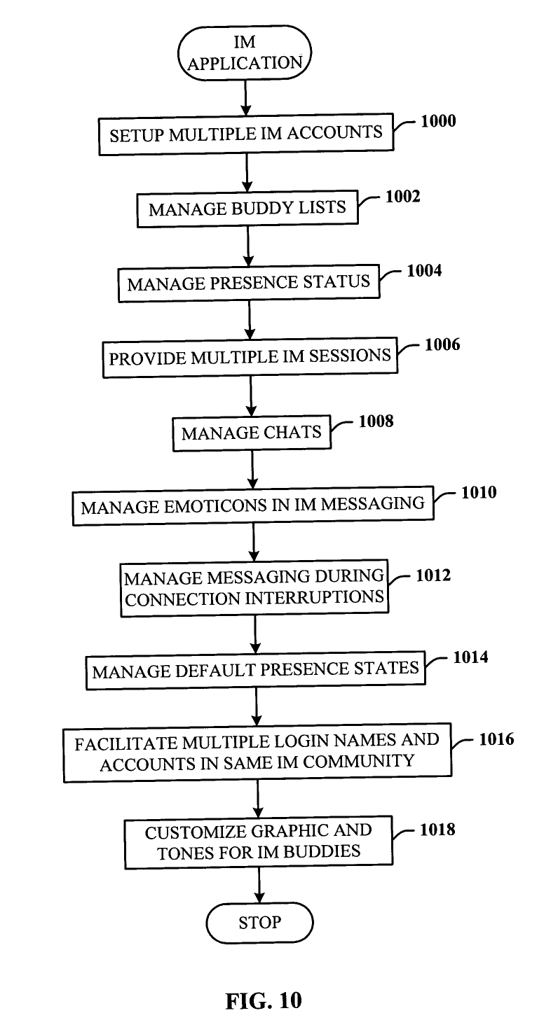

Referring now to FIG. 10, there is illustrated a methodology associated with an IM application to provide instant messaging functionality in accordance with the invention. At 1000, the user sets up one or more accounts. Support for three primary IM Communities is provided, e.g., AOL, MSN, and Yahoo! In a more robust user interface, additional communicates can be provided such that the user can access more than three accounts. At 1002, the capability to manage Buddy lists is provided. The user can add a new buddy and block a buddy via the device. At 1004, the IM application provides the capability to quickly change presence status from the device. The status option includes IM Community-specific presence states. The user can create a custom presence state from the device (e.g., “on the bus”).

All buddies can be implemented in a single view under a separate TAB window with visual icon indicators of their community subject to business terms around icon use. A Buddy name from the homepage (or desktop) appears the same on the device for IM Communities that allows buddy nicknames that are different from logon identification. At 1006, multiple IM sessions are allowed at the same time (e.g., multiple chat sessions within an IM Community). Multiple IM sessions from different communities (e.g., Yahoo IM to Yahoo buddy and MSN IM to MSN buddy sessions run concurrently) are allowed.

At 1008, the user can manage chats using the IM application. Chats are removed when the WMD device is powered down (or powered up). During conversation, old messages are removed cyclically. The exact history depth can be established according to flash/RAM memory budgeting. In case the user signs off intentionally, the chats will be closed. Where the wireless connection to the server is lost, the typing area is disabled. However, in another implementation, the writing area remains open allowing the user to complete the message, but caching the message for transmission when the connection is re-established. This can be cached in the WMD, or when the connection is re-established, at the server, and from the server, transmitted to the recipient when the recipient comes back online.

At 1010, the user can manage emoticons via the IM application. The user can insert and send one or more emoticons using key stroke equivalents. Alternatively or in conjunction with the key stroke equivalents, an emoticon can be inserted into a message using a special emoticon key. IM Community-specific preset emoticons can be received subject to .gifs parameters that are defined and included in the device.

At 1012, the user can manage messaging during a connection interruption. User presence status does change due to a temporary loss of network connection that is less than two minutes, for example, while device reacquires an active session. Messages queued during the two minute non-service interval are delivered to the recipient device as a continuation of the chat session when connection is reinstated.

At 1014, the IM application facilitates the management of the default presence state. The user default presence state is set as ‘Mobile’ when logging in from a device, to the extent that an IM Community supports that presence. The user default presence state is customizable. At 1016, the capability is provided to have multiple login names and accounts within same IM Community. This takes place by deprovisioning and reprovisioning the service through the Settings application. At 1018, the capability to customize graphics and tone associated with IM buddy on the device is provided.

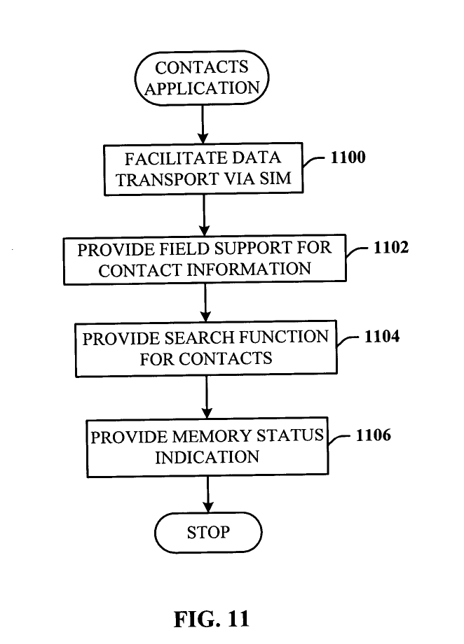

Referring now to FIG. 11, there is illustrated a methodology associated with a contacts application to provide contact functionality in accordance with the invention. At 1100, SIM (Subscriber Identity Module) addresses and SMS messages can be copied, if resident on SIM, when the SIM is inserted into WMD device. Some manual reconciliation of data can be performed, if needed (e.g., if Ivy PPC and Ivy Work are entered as two different contacts). At 1102, support for the following fields is provided: First Name, Last Name, E-mail Address, Secondary E-mail Address, Home Phone, Work Phone, Mobile Phone, Other Phone, IM Buddy Handle, IM Buddy Nickname, and Physical Address. Other fields can be provided

At 1104, support is provided for a new entry function directly into Contacts and a search function within Contacts. At 1106, memory status indication is also provided. The memory status indicator provides the capability to show the user they have 147 Contacts out of a possible 500, for example. An upper limit on the number of messages is associated with the size of the available memory of the WMD device.

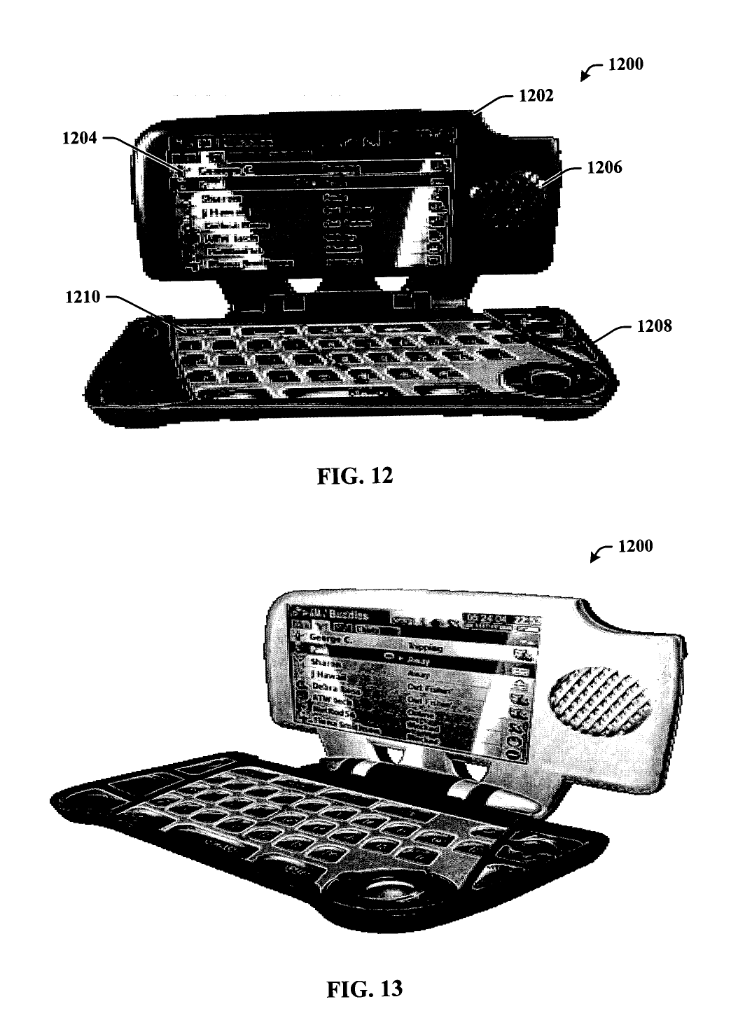

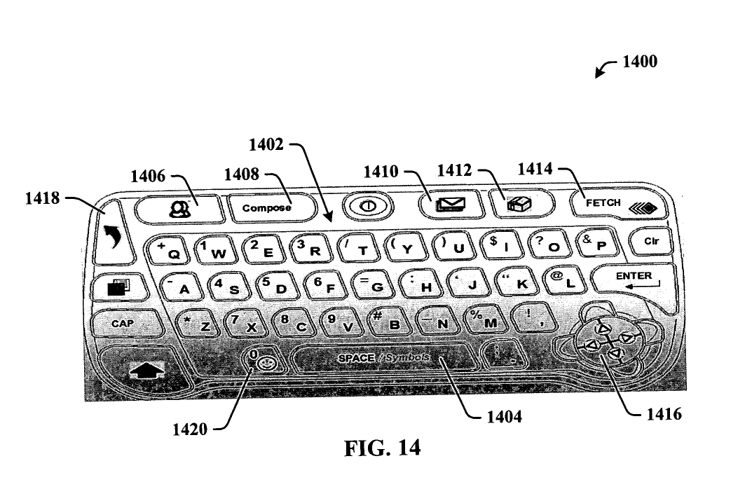

Referring now to FIG. 12, there is illustrated a front view of one implementation of a WMD 1200 in accordance with the invention. In this particular implementation, the WMD 1200 is of a slim-line clamshell design such that when closed, it can be conveniently placed in a pocket, purse, or bag of the user. When opened, the user is presented with a hinged two-part device, a first portion 1202 of which is principally to house a display 1204, which can be an LCD color display for presenting text, video information, and graphics. A speaker 1206 located in the first portion 1202 next to the display 1204 facilitates the output of audio and/or voice signals. A second portion 1208 includes a keyboard 1210 (e.g., a membrane or sealed keyboard that is resistant to the outside contaminants such as rain, dust, etc., that can affect operability of the device 1200) and other controls and input devices that are described in greater detail hereinbelow (see FIG. 14). The keyboard 1210 can be replaced with the Braille input/output (I/O) device such that tactile I/O can be processed to support visually and/or hearing impaired users, for example. When closed, the first and second portions (1202 and 1208) mate such that the display 1204 and keyboard 1210, for example, are protected.

The WMD 1200 includes a messaging oriented physical design that provides convenient and efficient user interaction for messaging in accordance with the invention. That is, the device can be conveniently held in one hand while operating and/or inputting information using the other hand. Alternatively, the ergonomic design of the WMD 100 is such that it can be held with both hands where, for example, the left hand can operate controls and keys of the keyboard 1210 within finger/thumb reach of the left hand, and the right hand operates controls and keys of the keyboard 1210 within finger/thumb reach of the right hand. Moreover, the keys and controls are suitably sized to facilitate thumb and/or finger access without inadvertently making a selection by an adjacent key. These ergonomic considerations also apply to the alternative WMD design of FIG. 29 infra.

Referring now to FIG. 13, there is illustrated an isometric of the WMD 1200 of FIG. 12. The WMD of the invention includes the capability to access e-mail, IM, and SMS accounts while mobile. As previously indicated, e-mail messages can include providers such as MSN, AOL, Y!, and ISP (Internet Service Provider)/POP3 portal access providers. IM messages can be processed from at least three generally known providers, such as AIM, Y!, and MSN. SMS messaging includes both domestic and international text messaging, and communicating messages to any SMS-capable device.

As indicated previously, the WMD features can include a clamshell design, full QWERTY keyboard, a 4K color screen (minimum 240×160 1/8 VGA), quick access to incoming e-mail, IM chats, and IM buddies via fixed keys, tone, tactile, and vibration notifications, a personalized color scheme and buddy personas, and easy access to portal-specific emoticons.

In a more robust implementation, the WMD can accommodate browser support along with mMode content, multimedia messaging via MMS messages, and include polyphonic ring tones and a camera accessory. Increased local memory capacity can also facilitate support for preloaded games and easy access for downloads. The display can be an increased resolution to, for example, a 65K color screen. Memory can include removable non-volatile memory (e.g., flash memory). In a more robust implementation, mass storage capability can be provided using a mechanical microdrive housed within the device housing. The WMD can also include push e-mail support. The WMD can also include geographic location technology such as GPS (Global Positioning System) or a similar technology.

The WMD provides at least 850 MHz and 1900 MHz GSM/GPRS (General Packet Radio Service) support, the capability to attach a headset for voice, SIM card (pre-inserted into device) support, charger with mini-USB connection, and monaural earbud. Where desired, the WMD can affix to an accessory that facilitates attachment to a belt or to a purse strap.

Applications and software can be employed to facilitates wireless activation of user account, the capability of OTA delivery of account settings, an IM client that facilitates access to any number of messaging providers (e.g., AIM, Yahoo! and MSN Messenger, ICQ, and Wireless Village), the capability to insert and receive audio or visual “emoticons” during the IM experience, and the capability to access a consolidated inbox that supports a plurality of e-mail accounts with access to, for example, AOL Mail, MSN Hotmail, Yahoo Mail, ISP mail, and other POP3 mail accounts, along with SMS messages received and sent from the device. The applications/software allow the user to sort mail in the mail account with the capability to present only one specified e-mail account or just SMS, and perform other conventional e-mail operations such as forwarding, replying, replying to all, deleting messages from device, and deleting messages from the server. The applications/software can also provide a standard GSM-compliant voice dialer, and wireless synchronization of an address book via a synchronization software, e.g., SyncML.

The user can quickly and easily activate the device after purchase from a retail location. Use of the WMD device begins “out of the box” without the need to go online or place a phone call for activation. Thus, all activation steps can be completed directly from the device. Additional and/or optional activation can be included via the Internet (using, e.g., a personal computer), a telephone call, or through a retailer. The user can be issued an additional set of credentials for access to all of the various business systems, which credentials can be downloaded into the device to facilitate seamless, user independent intervention access to various network elements. SIM information can be automatically read from the SIM and passed to the activation server. Similarly, a user can access the stored information on the SIM and upload it to the WMD.

A user with an existing telephone number can transfer that phone number to the WMD for voice+data or data only usage. This includes, for example, GSM and TDMA (Time Division Multiple Access) communication devices. Since a user who is an existing subscriber has already submitted subscriber information, if the WMD device is replaced due to failure or loss, the existing subscriber can select an “existing customer” option during activation to bypass most of the activation process presented according to the activation wizard.

A user needing a replacement SIM can use the WMD without going through the activation wizard again. The user is prompted to confirm basic information, if necessary, from a business security perspective. The WMD facilitates the use of shortcut (or “hotkeys”) at the top of the keyboard to bring user directly to an Inbox window and Compose Message window from anywhere. The user can send a message to combined e-mail and SMS recipients in one operation. A message to an SMS recipient can be prevented from being sent if the message exceeds a character limit. Mailboxes include: Inbox (includes draft messages) and Outgoing Mail. A user can filter e-mail to show SMS only, e-mail account #1 only, e-mail account #2 only, and so on. Within filters, the user can sort by sender, date, subject, for example. A “Find” folder facilitates performance of a keyword search through all messages.

There is also provided the capability to add a sender e-mail/SMS to new or existing contacts via an “Address Clipboard” feature. The user can edit and create new templates, create and insert template messages, and choose to insert pre-defined template messages into the text body of an e-mail or SMS. Messages in a “view” mode are read-only. The user can change the text size of the message body for easier viewing.

A “More” button will appear at the end of a message when the message file is larger than 1 Kb downloaded. User can continue to download the rest of the message. The user can also be notified of a SMS or e-mail message by a banner that drops for a predetermined time duration (e.g., 5-7 seconds) and displays the buddy name, action, and runs the Alerticon. If there is more than one new mail message, a “New Mail” icon is presented and the number of new messages displayed.

IM features further include a Chats “hot key” that brings the user directly to a “buddy list” window from anywhere within the user interface. Existing “buddies” can be imported for each community. A Buddy appears with a selected “nickname” and not always the Buddy ID. Buddies can be displayed alphabetically, and offline buddies are displayed at the bottom of the list in offline status. Each buddy has a status icon, status title, and a personalization icon. The default is a community ‘Alerticon’ but the user can select personalized Alerticons from a local list. The user has the capability to add a “New Buddy”.

In one implementation, the user can engage in multiparty chat. The user can send community specific emoticons to buddies in chat sessions, which are accessed via an emoticon button on the keyboard. The button brings up a “palette” of community-specific emoticons each of which is assigned to a different key on the keyboard. The user presses the key associated with an emoticon and the emoticon is inserted in the open chat window. The user is notified of a new chat message from a buddy or when a buddy logs on by a banner (similar to the SMS banner) that drops for a predetermined time duration (e.g., 5-7 seconds) and displays the buddy name, action, and runs the Alerticon. The user can also choose to insert pre-defined template messages into the text body of a chat and, edit and create new templates.

In an optional add-on, the WMD can employ a voice dialer. The user can check dialed, missed, and answered calls. Voice-mail can be accessed by a “press and hold” on a shortcut key. Speed-dial shortcuts can also be assigned. Contact phone numbers can be accessed using a combined alphanumeric smart search. New telephone numbers can be added to Address Book contacts or a new Contact created. Missed calls from the same number are listed in call logs with the number of calls in parentheses, and the user can access the times of the missed calls from an options menu. When dialing or receiving a call from a number already stored in contacts, the Contact Name appears with the type of phone in parentheses, e.g., “John S (cell)”. The user can reject an incoming call or send it to voice-mail.

Some of the settings include screen brightness, color scheme, and a welcome note. Related to IM, an account can be added, passwords changed, account deleted, account status accessed, chat history saved, and auto-login provided. With respect or e-mail, the user can add new account (which launches account wizard), manage pre-defined and POP3 mail, change password and account name, access mail folder management, POP3 and SMTP server management (where applicable), advanced settings (e.g., sync schedule, auto signature, prompt to add new contact, and download message capacity in Kb's). The user can review network connectivity, manage smart accessories to the device (via PMG—Personal Mobile Gateway, for example), manage the device security PIN (to lock the device), adjust sound features (e.g., volume, and click noises), set date and time parameters (e.g., set date and time, format, and alarms), perform a version upgrade, and enable synchronization (via SyncML).

The user can manage and access status information. The IM status can be set “globally” for all communities at the same time or for each community individually. The capability to set “custom” statuses is provided for communities that support this feature from mobile devices. A user can log-in to or log-out from any community using the options menu (the user has the option to save a password). During the sign-in process community icons appear in the status bar (on the top of the window). If user has not provisioned any IM communities, the IM status window automatically directs the user to the option menu to select “Add New Community.”

In e-mail status, the user can manually sync e-mail by selecting send/receive. The user is notified of the connection status of each provisioned e-mail account. Each e-mail account has an associated icon. Status of sync or the connection is displayed as a specific icon (to the right of the e-mail account listing). From the Options menu, the user can send/receive for specific accounts, view details of that account, remove account, add a new account, and go to account settings. For any send/receive that fails, the user is notified when and why the sync failed, e.g., “authentication on mail server failed”. Removing accounts for IM or e-mail will bring up a confirmation window. The user can manage profiles to include customizing ring tones, volumes, notification settings, for example, as indicated supra.

Address Book management includes the import of existing address books via wireless sync. Such sync can also be performed over a wired connection. A new contact can be added manually to include the following contact fields information, e.g., first name, last name, nickname, mobile phone (2 entries), main phone, work, home phone, e-mail (2 entries), fax, page, notes, postal address, web address, and IM (3 entries). A sender of a received message can be added to Contacts (when mail, IM, or SMS is received). Group lists can also be defined for contacts. The user can send e-mail/SMS/IM or call a contact directly from the Address Book. Contacts can be sorted by First Name or Last Name, for example.

Fetch is a button and GUI (graphical user interface) popup that allows the user to rapidly view and respond to all newly received unread messages (e.g., e-mail, SMS, and IM). Fetch also facilitates the review of all Draft messages. Message items in the Fetch list appear in the order they occur, with the last received message in the 2nd list position. The first list position is reserved for a “previous” function that will switch the user back to the screen previously viewed the last time the Fetch button was pressed, allowing quick navigation between active and newly arrived chats, messages, etc. Although the previous function is first on the list, the cursor automatically highlights the most recent new mail item. The send/receive function is at the bottom of the list and allows the user to check for new mail. The Chat icon is animated if there is a new message received from a buddy. A “new e-mail” line lists the number of new e-mails and provides the user with a shortcut option to get to the inbox and check new messages. The user can easily access the time a chat or other message was sent.

Synchronization allows the user to conduct imports from a device. The user is not required to go to a wired web site to perform this operation. The WMD can conduct ongoing syncs where information entered into other address books and devices is synced. The user can interact with a broad range of existing address books. The Help feature allows the user to interact with live online help via a “Help Buddy” chat application. The user has access a directory-based troubleshooting guide and contact information for care representatives and online help.

The user/customer is able to perform the following functions from the WMD: add, remove, or update portal subscriptions; make a payment on an account; and change rate plan. In one implementation, device based updates can be obtained by PC web access to change e-mail address (for billing purposes), update/change credit card number for monthly charges, and change a physical address. In another implementation, these actions can be performed directly from the WMD. Additionally, the following services are available via the WMD: Help Buddy access, Troubleshooting Help pages, and Contact information for online help and customer care support. The following services can also be accessed via the PC: an interactive troubleshooting wizard and, device and application support and FAQs (Frequently Asked Questions).

It is to be appreciated that device updates/patches can be pushed OTA to the WMD, with or without user intervention. In many cases, user intervention is required, but in extreme cases, updates and/or patches are pushed to the device without user intervention. It is also within contemplation of the invention that application updates and/or expansion modules can be pushed OTA to the WMD for hosting.

Referring now to FIG. 14, there is illustrated one implementation of a keyboard 1400 that can be employed with the WMD of the invention. The keyboard 1400 includes a full QWERTY-style character set of keys 1402, with selected keys facilitating the input of special characters (or symbols) more commonly used in messaging (e.g., +, numbers 0-9, @, #, /, $, and ?). A space bar key 1404 allows selection of the special characters (or symbols), as well as inputting spaces to the message.

The keyboard 1400 also includes one or more dedicated keys that facilitate immediate execution of desired functions. For example, a first dedicated key 1406 allows the presentation of an interface for viewing and selection of messaging buddies. Similarly, a second dedicated key 1408 allows the user to compose a message for sending. When selected, a corresponding user interface is presented to allow composing and sending of a message for transmission ova messaging, e-mail, and/or SMS, for example. A third dedicated key 1410 facilitates access to a mailbox for e-mail accounts of any one or more e-mail providers.

A fourth dedicated key 1412 symbolizes a home interface to present general status information and a navigation point to other functions of the device. A fetch key 1414 facilitates the download of messages from any of the subscribed message sources, e.g., e-mail, SMS, and IM providers. Other keys and controls facilitate cursor navigation on the display and screen navigation. For example, an arrow navigation tool 1416 allows the user to move the cursor around the interface to select various options provided thereon. A back key 1418 allows quick back paging of screens presented by the operating system of the WMD.

An emoticon key 1420 is provided as a shared dedicated key—it is shared with another symbol (e.g., numeral zero). In response to selection thereof, the device displays a collection of graphical artifacts (emoticons) on a palette or menu that facilitate communicating the emotion or state of the user. Once selected, the emoticon is automatically inserted into the message at an appropriate place, transmitted along with the message to the recipient. An emoticon can also be initiated by entering a combination of key strokes that are interpreted by software on the device to equate to a graphical emoticon representation. For example, a graphical smiley face can be entered as three keypad characters: a colon “:”, followed by a hyphen “-” (optional), followed by a right parenthesis symbol “)”, the interpretation of which results in the following symbol [symbol] being entered into the text message.

A default set of emoticons can be provided in the wireless device for selection by the user. Updates to the default set can be obtained by downloading new emoticons from, for example, a remote network site. It is to be understood, however, that software can be installed on the wireless device that facilitates the customization of one or more of the existing emoticons, and/or creation of new emoticons for use by the user. It is further to be appreciated that in an alternative implementation, the keyboard 1400 provides the capability of programming any of the keys thereof to facilitate the input of more commonly used emoticons that he or she uses more often than others. For example, a sad-face emoticon “ [symbol] ” can be programmed in association with the S key such that when the user presses the S key, the corresponding sad-face graphical emoticon is input into the message.

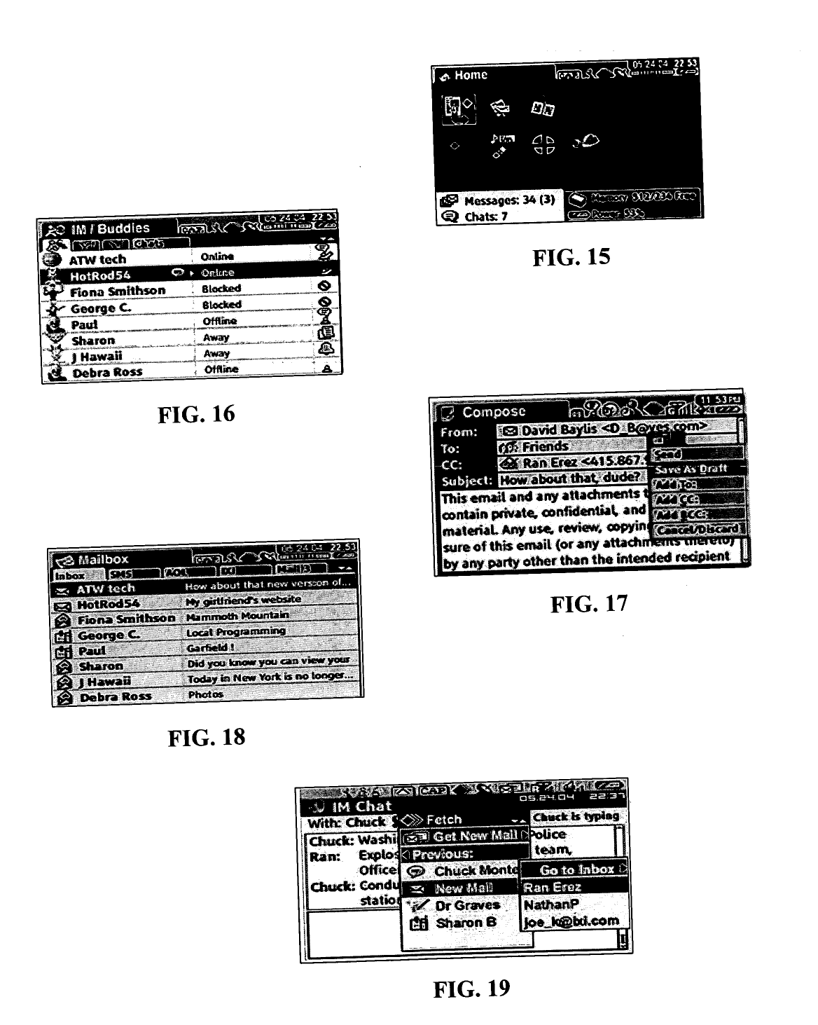

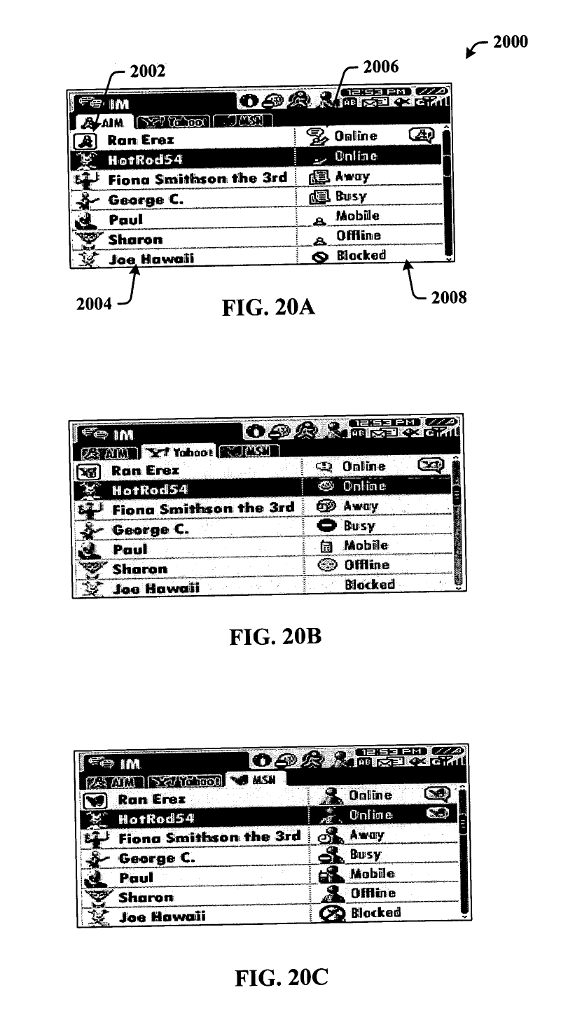

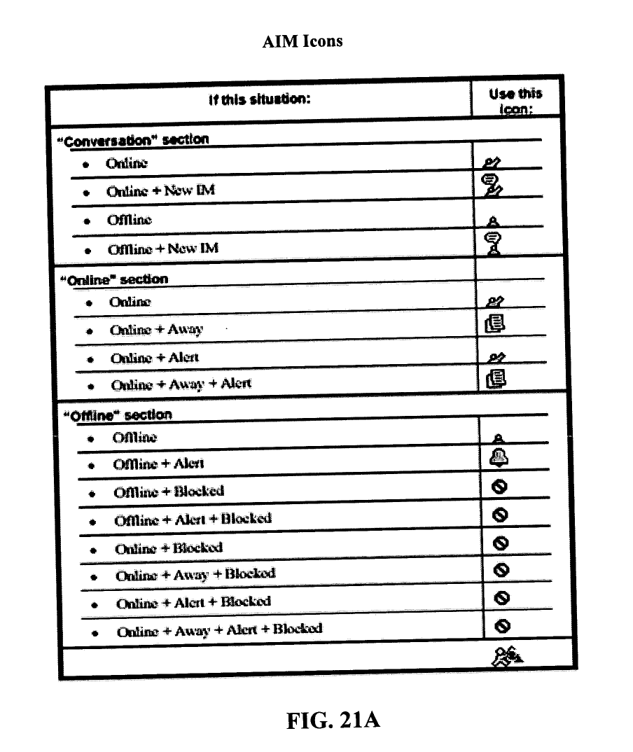

FIG. 15 depicts a screenshot of a Home screen in accordance with the user interface of the invention. FIG. 16 shows a screenshot of an IM Buddies screen in accordance with the user interface of the invention. FIG. 17 illustrates a screenshot of a Compose screen in accordance with the user interface of the invention. FIG. 18 shows a screenshot of a Mailbox screen in accordance with the user interface of the invention. FIG. 19 depicts a screenshot of an IM Chat screen in accordance with the user interface of the invention. Following is a more detailed description of the user interface screens of FIGS. 15-19, and variations on the user interface illustrated in FIGS. 20A-C, 22A-C, 23A-T, and 25A-E, that facilitate always-on messaging in accordance with the invention.

The device of the subject invention is configured with software which provides a graphical user interface (GUI) that facilitates access to a plurality (or aggregation) of IM providers. Referring now to FIGS. 20A-C, there are illustrated screen features of an IM interface for three providers in accordance with the invention. The IM Lists Folders screen presents community Buddies lists and Status information. Pressing Enter on a highlighted Buddy invokes the corresponding community Chat screen. Also displayed is an active or newly received Chat indication and corresponding icon (Alerticon). By way of an Option Menu, the user can add/remove Buddies, and view/edit/Link to the Buddy's Contact Profile, or Block and Unblock the Buddy.

In this particular implementation, the IM List screens provide up to three folder TABS, one for each supported community Buddy list. The GUI 2000 of FIG. 20A shows the tab information associated with the AIM portal, FIG. 20B shows tab information associated with the Yahoo portal, and FIG. 20C illustrates the tab information associated with the MSN portal. The description of the GUIs for FIG. 20B and FIG. 20C is similar to that provided herein with respect to FIG. 20A. Community Buddy List TABS are only presented if the user has previously registered to the service. Each TAB displays the community's name and icon.

IM List—Line Composition and Related Features. Each line of the Buddy list interface contains four columns of information which include the following elements, from left to right: a first column 2002 that displays a Community default Alerticons; a second column 2004 that displays the screen name of a Buddy; a third column 2006 that presents community-specific icons about the status of the Buddy in the second column 2004; and a fourth column 2008 that presents status information about the Buddy in the second column 2004. Each of the three IM communities has a “Branded” default Alerticon that can be assigned to a Buddy in the third column 2006 according to the cases below. All IM Community default Alerticons can incorporate animation and audio, and be used as Banner Alerts for new received IM text.

When a user first imports the Buddy from an IM server (not Linked to a Contact) the corresponding Community Branded Alerticon of the third column 2006 is automatically assigned to the Buddy. If the user desires, they can create a Link between the Buddy and a Contact, and by access to the Contact Profile, change the IM Community default Alerticon of the first column 2002 to an alternate selection. In one implementation, an IM-only Buddy that is not linked a Contact cannot change the Community default Alerticon. Upon creating a link between an IM Buddy and an existing Contact, the Alerticon can be changed to whatever Alerticon is assigned to the Contact at the time of creating the Link.

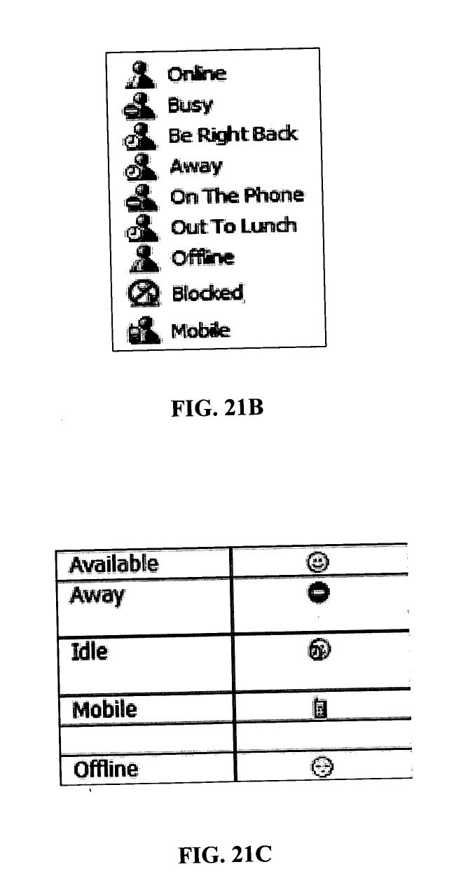

FIG. 21A illustrates community-specific presence icons for the AIM portal related to conversation, offline, and online status. Icon behavior can be programmed to conform to each portal's standards. FIG. 21B illustrates community-specific presence icons for the MSN portal, related to Online, Offline, Busy, Be Right Back, Away, On The Phone, Out To Lunch, Blocked, and Mobile. FIG. 21C illustrates community-specific presence icons for the Yahoo portal related to Available, Away, Idle, Mobile, and Offline. Pre-set presence text and custom presence text are supported such that other indicators can be configured by the user. The non-default Alerticon assignment and Link to Contact can be stored in non-volatile flash memory to prevent erasure upon removing and replacing the Battery or during a hard reset.

Name. The Buddy's IM Name/Screen Name (AIM), etc., can be displayed as imported from a specific community IM server. This Name is used on IM Buddy lists and corresponding IM screens only. It is not used for Contacts, unless the user types this name in the first and/or last name field in Contact Profile.

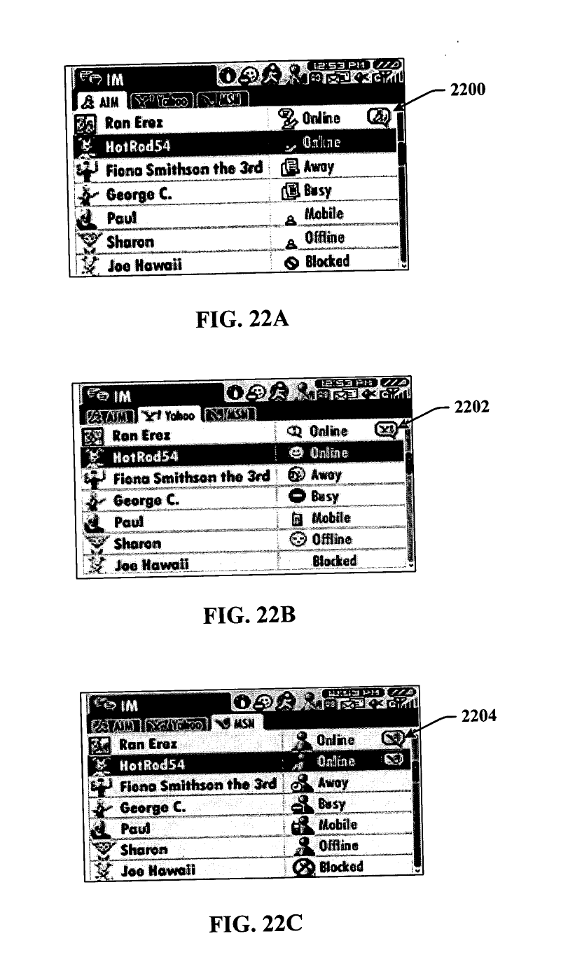

Referring now to FIGS. 22A-C, there are illustrated screenshots of animations of Community Chat Icons in accordance with the invention. A Community-Specific Chat icon will appear at the right most position of the line if a Chat is open between the user and the respective Buddy. This icon will continuously animate if any unread Chat text was received, and becomes static (as shown in the table below) after the Chat was opened to read the new Chat text, and the user then exits the Chat screen. If the Buddy has gone Offline, the inactive Chat Icon ( [symbol] ) is displayed. FIG. 22A shows a chat icon 2200 for an AIM portal. FIG. 22B shows a chat icon 2202 for the Yahoo portal. FIG. 22C shows a chat icon 2204 for the MSN portal.

Animation Timing for Each Community Chat Icon in Fetch. In Fetch, where multiple animating Community Chat Icons from different communities are displayed in varying order, each Community Chat Icon is timed differently (staggered) so that the branded side of each community icon is not shown in the paused position at the same time. In addition to being an entertaining effect, staggered animation further differentiates between an AIM and MSN new Chat.

Chat Management and Icon Display. The Chat Icon appears when an active (Static) or new Chat (Animating) from the corresponding Buddy is present. When closed, Chat sessions are deleted and their corresponding icons are not displayed. Closing Chat sessions can be managed in the following ways. A chat session will auto close when a Buddy has gone offline for a predetermined duration of time, e.g., ten minutes or more. When buddy goes offline and has an open Chat, the Inactive Chat Icon ( [symbol] ) can be displayed. A chat session will also auto close when no chat activity from either the Buddy or user has occurred for a predetermined duration of time, e.g., ninety minutes. This duration parameter can be configured by the user in Settings.

The chat session can be manually ended when the user selects a “Close Chat” option menu item. Sign-off occurs when the user signs-off from an IM service. When the power is turned off and turned on again (recycled), all open Chats will be closed and indications are deleted from the IM and Fetch screen lists.

Referring now to FIGS. 23A-C, there are illustrated screenshots of community-specific option menu items in accordance with the invention. FIG. 23A shows a screenshot of the option menu for the AIM portal. FIG. 23B shows a screenshot of the option menu for the Yahoo! portal. FIG. 23C shows a screenshot of the option menu for the MSN portal. The following table illustrates some of the options that can be provided for three providers in a dropdown Options menu.

| AIM | MSN | Yahoo! |
|---|---|---|
| New Message | New Message | New Message |
| Add a Buddy | Add IM Contact | Add a Friend |
| Delete Buddy | Delete IM Contact | Delete Friend |
| Block/Unblock | Block/Unblock IM | Ignore/Un-Ignore Friend |
| Buddy | Contact | |
| View Buddy ID/Link | View IM Contact | View Friend ID/Link |
| | ID/Link | |

The New Message option can be executed by selection or is the same as pressing Enter on the keyboard. If a Buddy is online, New Message opens a new chat with this Buddy. If the Buddy is offline and Buddy profile is not linked to a contact profile, for the offline MSN IM Contact, this opens a new compose message, with the Buddy's IM ID in the “To:” field. These portals support e-mail alternatives to IM. If not supported, a notification popup appears, e.g., “Sorry . . . You can not send an IM to an Offline Buddy.” For the offline AIM Buddy the New Message option opens a new compose message, with the Buddy's IM ID in the “To:” field. If not supported, a notification popup appears, e.g., “Sorry . . . You can not send an IM to an Offline Buddy.” For the offline Yahoo! Friend, the New Message option sends a Delayed IM. If not supported, a notification popup appears, e.g., “Sorry . . . You can not send an IM to an Offline Buddy.”

If the Buddy is Offline and the Buddy is linked to a Contact Profile, pressing Enter on the keyboard opens a new Compose Message, with the Buddy's e-mail address in the “To:” field (if the Buddy has one address). If in the above case the Buddy has multiple addresses, the address selection popup is opened and presented. The last used address will be highlighted. Add New Buddy/Friend/IM Contact. Adding a new Buddy can be done from each specific Portal (via the Option Menu within the corresponding portal IM Folder), which opens a “New Buddy” popup.

FIGS. 23D-F illustrate the New Buddy popup screens for the three sample providers. FIG. 23D shows the New Buddy popup for the AIM portal. FIG. 23E shows the New Buddy popup for the Yahoo portal. FIG. 23F shows the New Buddy popup for the MSN portal. The user types the new Buddy unique ID and presses Enter when “Add Buddy” is highlighted. If the new Buddy was located on the IM server, an Add request is sent. If new Buddy was not found on the server, FIGS. 23G-I illustrate the error popup screens that will be presented for the three providers. FIG. 23G shows the New Buddy error popup for the AIM portal. FIG. 23H shows the New Buddy error popup for the Yahoo portal. FIG. 231 shows the New Buddy error popup for the MSN portal.

Delete Buddy. When selecting a Delete Buddy/IM Contact/Friend Option menu item, FIG. 23J illustrates a confirmation popup for the user to confirm and invoke the Delete function. Block/Unblock Buddy—selecting this option toggles between the Blocked or not Blocked state of the Buddy, marked by an icon and a text. This option is also accessible via the Remove Buddy screen shown in FIG. 23J. View Buddy ID/Link-selecting this option opens the Buddy Profile sub-screen.

FIGS. 23K-L illustrate a view of a Buddy/IM Contact/Friend ID/Link profile card subscreen of the invention. FIG. 23K shows the MSN profile card for a “Remove Link” option. FIG. 23L shows the MSN profile card for a “Link to a Contact” option. The Buddy ID/Link displays the following Information: Buddy name, status icon, IM ID, and Buddy IM address (read-only). If the Buddy is linked to a Contact Profile, it will show the Contact's Alerticon and Contact name, and add the button for removing link if the user so desires. If the Buddy is not linked to a Contact, selecting a “Link to Contact” button initiates the Link sequence. Each link popup can be made community specific.

Link-to-Contact Sequence. When “Link to a Contact” option of FIG. 23L is selected, the popup illustrated in FIG. 23M opens and provides the following actions. The user can choose to link the Buddy to an existing contact profile, or to a new profile. The user cannot edit the IM address and the IM Name, since this is a read-only field. Selecting “Create New” creates a new contact list entry, with the user entered Name and the IM address information. Selecting “Add to Contact” opens the “Select Contact” popup, whereas Cancel closes the popup.

Link to Contact Screen Behaviors and Rules. Certain dynamic option Menu Items for a linked or non-linked Buddy are possible to simplify the flow and interaction model. As such, trade-offs can be considered for implementation thereof. When the Link-to-Contact button is highlighted in the screenshot of FIG. 23M, the First Name and Last Name fields are not displayed. These are displayed when the “Create New” option is highlighted. When the user has entered any name data in either or both the First/Last Name fields, then navigating to the Link-to-Contact button removes both the First and Last Name fields. When Cancel is highlighted, the First and Last Name fields are displayed.

When the user has either name field highlighted, none of the selection buttons are highlighted. Minimum Name entry is at least one character in either the First or Last Name field. Alert Popup is presented if the user presses Enter on the “Create New” option and there are no name characters entered. The following message appears, “Sorry. You must enter at least a first or last name to Create a new Contact Profile.” If the user enters a name that already exists in Contacts and selects “Create New”, a popup is displayed related generally to “You already have a Contact <name>, do you want to create a second Contact Profile for <name>? (Yes/Cancel)”. It is to be appreciated that alternative messaging can be implemented.

When selecting the Link-to-Contact button in the window of FIG. 23M, the window of FIG. 23N appears to allow the user to select a contact. The user can then chose which contact profile to add the IM ID. A Community tab can appear empty if the device is logged out of the community, or the user has no Buddies in the list. FIG. 230 illustrates a screenshot of a message presented when the user is not logged in. As the Buddy list is not stored locally, the Buddy list can is presented after sign-in. FIG. 23P illustrates a screenshot of a Sign-On popup window for an AIM user that opens when presses Enter in the sign-in popup sequence. FIG. 23Q illustrates a screenshot of a Sign-in popup window for an MSN user that opens when presses Enter in the sign-in popup sequence. FIG. 23R illustrates a screenshot of a Sign-In popup window for a Yahoo! user that opens when presses Enter in the sign-in popup sequence. FIG. 23S illustrates a screenshot of an AIM window that open when no buddies are on the user buddy list. FIG. 23T illustrates a screenshot of a New Buddy popup window that opens to add an AIM buddy.

By way of example, and not by limitation, the following table lists community specific terminology used in accordance with the three providers of the invention.

| MSN | Yahoo | AIM |
|---|---|---|
| Add Contact | Add a Friend | Add a Buddy |
| Display name | Yahoo! ID | ScreenName |
| Auto sign-in | Auto Sign In | Auto Login |
| Added to contacts: | <ID> added | |
| Display name saved. | Yahoo! ID Saved | Buddy Saved |
| Auto sign-in OFF | Disabled | |
| Auto sign-in ON | Enabled | Login Automatically |
| Contact list updated | Friend List Updated | Refresh List |
| Signed in | Signed In as <ID> | Sign On |
| Signed out | Signed Out | Signing Off |
| Removed from | Removed from Friends | Delete |
| contacts: | | |
| Contacts | Yahoo! Friends | Contact List |
| Contact list is full | Your Friend List is full. | |
| | Please delete an existing | |
| | Friend to add a new one. | |
| Invalid e-mail | Invalid Yahoo! ID | <abc> is not available |
| address | | |
| Sign-out failed. | Sign Out Failed | Screen Name not |
| | | valid |
| Contact already in | That Friend is already in | |
| list | your Friend List. | |
| Conversations | Conversations | Instant Messages |
| Delete contact | <ID> deleted | |
| Chat | Chat | Chat |
| Sign out | Sign Out | Sign Off |
| Display name: | Display Name/Nickname | N/A |
| E-mail address: | Yahoo! ID | Buddy Name |
| Sign out and end all | Sign Out and end all | |
| conversations? | conversations? | |
| Delete contact | Delete Friend | Delete Buddy |
| Signing in | Connecting to Yahoo! | Connecting |
| Signing out | | N/A |
| Block contact | Ignore (remove) | Block |
| Contact info | View Info | Get Info |
| Messenger | Y!Messenger | AIM |

FIG. 24 illustrates a table of some keyboard key controls and functions of the invention. The table illustrates the control name, associated control symbol or icon, and control description.

FIGS. 25A-E illustrate a number of screenshots related to a Help tool (or Help Buddy) of the user interface of the wireless messaging device of the invention. The Help tool provides guidance and/or advance information on user experiences that can occur with the product that are problematic or unexpected. The Help tool also provides information when a function is performed and the result is not as anticipated, and can furnish information on hidden or non-obvious advanced user functions, shortcuts and operation “tips” that are not readily apparent in either the product and/or user's manual.

The Help tool is accessed via the Home screen. When opened, Help folders offer three help methods: Live Support Chat, Help Pages of text indexed by topics, and Technical Support Information providing contact information for the user to call or access the Internet. These three Help methods are selected using TAB navigation. These tabs are sticky, that is, the tab last used when leaving the help pages will be the tab highlighted when returning to the help section.

The Help Buddy as defined is a single, persistent online resource for conducting a live Chat with a technical support assistant. As such, multiple Chat list screens or Buddies Lists are not needed, which provides the user with immediate Chat accessibility at all times. A user need only commence typing in the chat text field, select Enter, and receive responses. Additionally, the TAB help resources are in constant view of the user enabling online help to easily direct a user to local help content in Help Pages or technical support information.

A total of three hierarchical levels are provided for the “Help Pages” index, topic and detail text. If an Index (Top Level) item does not have many sub-topics, this “Sub-Topics” screen could be eliminated and the Detail popup would be invoked directly from the Index item.

FIG. 25A illustrates a Live Support screen in accordance with the help tool of the invention. Live Support functions as a normal Chat but without indications for the Help Buddy Presence Status (as the Help Buddy is always online), and without any links or dependencies to the user's presence status (the user is also always Online with regards to the Help Buddy Chat). Specific message protocols and system responses or notifications can be associated with each Help selection. As a separate application and community, the Help Buddy messages do not appear on Fetch. However, a number indicating new unread Help Buddy Messages can be displayed on the Help Icon in the Home Screen, and on the folder TAB in the Help Folders Screen. New received Help Buddy messages can be displayed on a Banner Alert with a dedicated Alerticon.

FIG. 25B illustrates a Help index list screen. A user can navigate the List and press Enter to open the sub-screen index of help topics for the selected topic. FIG. 25C illustrates a Help Sub-Topics screen. A user can navigate the List and press Enter to open the Help Topic Detail popup screen for the selected topic. FIG. 25D illustrates a Help Topic Detail popup screen. The user can scroll through the detail text descriptions. A last scroll position highlights the “Close” button. Pressing Enter when highlighted closes the Detailed Popup screen and returns the user to the next Help screen level up (Help Sub-Topics). The same action results by pressing an Up button so that the user can scroll the help page. When at the end, the Close button will highlight. Pressing Enter will close the screen.

FIG. 25E illustrates a Technical Support Information screen. This screen can be used to display technical support information, e.g., telephone and internet contact information. Although not illustrated, another Help screen can include an index to a number of existing and other options. For example, the Help screen can facilitate contacting not only Live Technical Support, but also a Billing Help Buddy to access billing information, Roadside Assistance to contact the nearest roadside assistance personnel, Emergency Medical to contact the nearest medical support and/or facilities, and a Bank associated with the user account.

The general architecture of the Help Tool described herein finds application not only with portable wireless devices, but also in other settings such as with home television systems, vehicle television and locations systems (e.g., GPS—Global Positioning System), and radio systems. For example, television systems provide menus and/or related options such that the viewer can access a Help system. In this context, the accessed Help menu can route the user to a live Help support representative whose video image is provided in a “face-to-face” interaction to resolve a setting or problem. In the context of a digital radio system, for example, the user can be connected to a Help representative using only audio interaction to provide help and/or resolve a problem. When employed in a cellular telephone that include video capability, either video or audio, or both, can be used to help the caller resolve a problem. When employed in a cellular telephone that include video capability, either video or audio, or both, can be used to help the caller resolve a problem.

Following is a general listing of Help categories that can be employed. General headings can include troubleshooting, establishing or maintaining a good communications connection, setup, storage and memory, error notifications, synchronization, and advanced user information. Subcategories for the troubleshooting category can include how to resolve the inability to send a message, open an IM, respond to undeliverable e-mail, how to perform a hard reset, and change credit card and billing information. The connection information can include support for GSM/GPRS connectivity, IM server connections, and e-mail server connectivity. The setup heading can include further information about a communication wizard and an activation wizard. The storage/memory category can provide further information about storage capacity of the WMD, the number of IM messages currently in store, the number of messages saved at a provider location (e.g., saved on AOL), and the number of contacts stored in the WMD.

The error notifications heading can include alerts for message storage, IM Buddies Lists and battery life. The advanced user category can include further information for advanced user such as useful tips, shortcuts, and other advanced information.

FIG. 26 illustrates a table of keyboard controls and functions associated with interaction with the Help tool of the invention. The table illustrates the control name, associated control symbol or icon, and control description.

FIG. 27 illustrates an Alerticon palette that can be accessed to associate icons with contact profile, in accordance with the invention. The Alerticon palette is accessed from the Contact Profile screen, and used for previewing, selecting, and assigning an Alerticon to a Contact. This palette sub-screen is scalable, presenting eight columns of items, four rows of thirty-two viewable icons per page. A scroll bar navigation and indication is used if more then four rows of items are provided.

The user can navigate the position of the Highlight (a 32×32 pixel enlargement) about the palette using the arrow navigation controls. Positioning the Highlight on any Alerticon for more the two seconds, for example, will play the animation with sound. The play action can be interrupted at any time by simply scrolling off that Alerticon, or by selecting it. Pressing Enter assigns it to the contact and closes the palette. The position of the Highlight in the palette is pre-set on the previously selected or default Alerticon.

FIG. 28 illustrates a table of keyboard key controls and functions provided associated with interaction of the Alerticon palette of the invention. The table illustrates the control name, associated control symbol or icon, and control description.

FIG. 29 illustrates a front open view of another implementation of a WMD 2900 in accordance with the invention. As before, the WMD 2900 is of a slim-line clan-shell design such that when closed, it can be conveniently placed in a pocket, purse, or bag of the user. When opened, the user is presented with a hinged two-part device, a first portion 2902 of which is principally to house a display 2904, which can be an LCD color display for presenting text, video information, and graphics. A speaker 2906 located in the first portion 2902 next to the display 2904 facilitates the output of audio and/or voice signals. A second portion 2908 includes a keyboard 2910 and other controls and input devices that are described in greater detail hereinbelow.

The keyboard 2910 includes a full QWERTY-style character set of keys 2912, with selected keys facilitating the input of special characters (or symbols) more commonly used in messaging (e.g., +, numbers 0-9, @, #, /, $, and ?). A space bar key 2914 allows selection of the special characters (or symbols), as well as inputting spaces to the message. The keyboard 2910 also includes one or more dedicated keys that facilitate immediate execution of desired functions. For example, a first dedicated key 2916 allows the presentation of an interface for viewing and selection of a mailbox that includes messages from any or all of the subscribed message types (e.g., instant messaging, e-mail, and SMS). Similarly, a second dedicated key 2918 allows rapid access to chat functions employed in the WMD 2900. A third dedicated key 2920 facilitates power and quick settings access via the user interface. A fourth dedicated key 2922 facilitates direct access and execution to the compose application to compose a message.

A fifth dedicated key 2924 provides quick access to the homepage (or desktop) of the device 2900. A sixth dedicated key 2926 facilitates a fetch function to retrieve messages from the subscribed portals. A seventh dedicated key 2928 provides quick access to an options menu. An eighth dedicated key 2930 facilitates the opening of a home screen or closing of popup screens. Other keys allow the user to interact with emoticons, access volume control and navigate up/down and left/right on the user interface, for example, and are described in keyboard key control tables provided herein with other applications and functions. The user interface of the device 2900 shows a login (or sign-in) screen for the MSN portal.

FIG. 30 illustrates the device 2900 where the user interface shows one version of a Home page in accordance with the invention. The Home page facilitates the selection of further system applications and options, for example, Mailbox, IM, Compose, Contacts, Status, Profile, and Support. FIG. 31 illustrates one version of a live support Help screen in accordance with the invention.

FIG. 32 illustrates a generally top view isometric of the WMD 2900 of FIG. 29 in a closed position. When closed, the first and second portions (2902 and 2908) mate such that the display and keyboard, for example, are protected. The device 2900 includes an outer support structure 3200 that facilitates ergonomics when handling the device 2900, and also for strapping the device to a belt or other parts of the clothing and accessories (e.g., a purse strap).

FIG. 33 illustrates a front view of the device 2900 in a closed position. An audio jack 3300 enables the user to use headphones or and earbud when interacting with audio signals. FIG. 34 illustrates an activation wizard screen for initiating activation in accordance with the invention. FIG. 35 shows one version of an account setup wizard screen in accordance with the invention. FIG. 36 depicts one version of a mail inbox interface screen in accordance with the invention. FIG. 37 illustrates one version of an instant messaging status screen for an MSN portal in accordance with the invention. FIG. 38 shows one version of a compose screen in accordance with the present invention. The user can enter the TO: information, SUBJECT: line information and message body text. FIG. 39 depicts one version of a fetch popup screen in accordance with the invention.

In summary, following are some of the many aspects of the invention. The user can purchase the WMD and activate the WMD in a number of ways: from a retail channel and self-activate the WMD, from the retail channel and activate the device in-store, from the retail channel and activate via telephone, from the retail channel and activate via wired web, and from a virtual channel and self-activate via the wired and/or wireless network.

Activation can further be implemented by issuing a new SIM. A new user can be issued a new SIM. An existing subscriber can be issued a new SIM with a new number, a new SIM that retains existing phone number, and an old SIM. An existing WMD subscriber can be issued a new SIM.

The subject invention supports an activation scenario where the activation process was interrupted. This can include resetting the activation process, and restarting the activation process at a point just before interruption, for example. Activation can fail because of an inability of the provider or the device to process the subscriber information. For example, activation fails because of the lack of correct data entered, or the subscriber fails credit card authorization. Activation can be pending when the user turns off device. Activation can be interrupted or fail where the user fails to setup either an e-mail or an IM account.

The user can setup access to a primary existing e-mail account, to second or third e-mail accounts, access to new e-mail account, access to an invalid e-mail account, access to a POP3 ISP account, and access to an ISP account not pre-configured. The user can setup access to a primary IM account, to second or third IM accounts, to a new IM account from the device, and to an existing IM account but the portal replies that the account is invalid. A final message can be presented to remind the user of their number for text messaging.

The user can sync their e-mail contact addresses to a network-based address book. The address book can be imported from a network and/or ISP. The system can address a scenario where the Sync fails. The user can manually enter e-mail addresses to the Contacts file, save e-mail address to the Contacts file after sending the e-mail, and add new e-mail address if the e-mail is open and active.

Users can manually enter phone numbers or save phone numbers from a SIM-based address book. The user is not allowed to change the IM buddy name that is sent from a portal to the Contacts file. The user can add a new buddy directly to the Contacts file. The user can view all e-mail/SMS messages in an Inbox, read a specific e-mail, change the status for all IM services, view all unread IM messages, view all “current” chats, start a new chat, switch between two active chats, and start a different chat while in a first chat. A buddy list can be viewed and separated by community.

A new SMS message can be composed with the number of characters displayed as the user enters the text. This facilitates limiting the SMS message to 160 characters or less, if desired. The user can accept an invite from a new buddy (someone else has added you). A new e-mail can be composed to one recipient (already in the Contacts file). The user can search for someone on the buddy list. The user can reply to an e-mail message, reply to an SMS message, get new e-mail (by manual pull), forward r-mail to one recipient, compose a new mail to mixed e-mail/SMS, and forward e-mail to multiple recipients.

The user can add a new contact, delete a message from the Inbox, view SMS messages only, sort messages by sender, delete a message after reading it, add someone to an existing (or current) chat, and add a new buddy (to New Contacts or add to Existing Contacts). The SIM can be read for old contacts. The user can manually log out of IM service, change status for only one IM service, add a new e-mail account, compose a new e-mail to someone not in Contacts (auto prompt to add after sending), add a new IM service (to device, already provisioned on desktop), and add a new IM service (no setup on desktop). The pre-paid account balance can be accessed by the user. Premium SMS content is provided for an added fee.

The user can create and send an IM to an offline (mobile) buddy, request a password reminder from a portal, send an emoticon, receive a message with an emoticon (on device), and receive a message with emoticon (not on device). A sender of an SMS can be called. The user can change an IM “Nickname”, and customize which emoticons are assigned to which key. An SMS message can be sent with more than 160 characters such that the message will then be processed in parts. The user can block a buddy, unblock the buddy, warn a buddy, and receive e-mail from someone not on the Contacts list.

Wireless coverage can be interrupted and resumed. The ring tone can be changed, and e-mail postponed (or saved to Drafts). The Draft e-mail can then be retrieved for sending or deletion. The user can create a custom status (pre-send) by customizing both the name and the icon. A custom filter of contacts/buddies can be created (e.g., most recently chatted/e-mailed with, or custom—“My Favorite Friends”). sunshine

The user can see how much memory is left, and attempt to get new e-mail when memory is full. An e-mail distribution list (e.g., of “classmates”) can be created and an e-mail sent to that distribution list. The user can pay by credit card, EFT from checking and savings accounts and reloadable Gift Cards.

FIG. 40 illustrates a block diagram of a first WMD 4000 (denoted WMD₁) in accordance with the invention. The device 4000 (similar to devices 100, 1200, and 2900) includes a processor 4002 for controlling all onboard operations and processes. A memory 4004 interfaces to the processor 4002 for temporary storage of data, instructions, and one or more applications 4006 being executed by the processor 4002. The memory 4004 can include fixed or removable flash memory, a physical microdrive (magnetic and/or optical), and the like, insofar as data volatility/non-volatility is considered. A communications subsystem component 4008 (e.g., a transceiver subsystem) interfaces to the processor 4002 to facilitate wired/wireless communications with external systems.

The device 4000 includes a display 4010 for displaying any information and/or graphics, for example, messages created and/or downloaded in accordance with the invention, related message content, and for displaying text information related to operating and using the device features. The display can be a touch-sensitive device that facilitates interaction by user touch and/or a suitable pen device. A serial I/O interface 4012 is provided in communication with the processor 4002 to facilitate serial communication (e.g., USB, and/or IEEE 1394) via a hardwire connection. This supports at least updating and troubleshooting the device 4000, for example. Audio capabilities are provided with an audio I/O component 4014, which can include a speaker for the output of audio signals related to, for example, recorded data or telephony voice data, and a microphone for inputting voice signals for recording, processing and transmission.

The device 4000 includes a slot interface 4016 for accommodating a SIM card 4018, and interfacing the SIM card 4018 to the processor 4002. Firmware 4020 is also provided to store and provide to the processor 4002 startup and operational data and instructions.

Although not illustrated, it is within contemplation of the invention that in a more robust implementation, the device 4000 can also include an image capture component such as a camera. The user can then take digital pictures, and transmit the pictures to a remote location or store the pictures locally. In yet another implementation, the device 4000 can include a video decoder for decoding encoded multimedia content that is received as a message in any format of instant messaging, SMS, e-mail, and MMS. The device 4000 also includes a power source 4022 in the form of batteries, which power source 4022 interfaces to an external power system or charging equipment via a power I/O component 4024.

The applications 4006 resident on the device 4000 can include, for example, an operating system for configuring and manipulating local data and settings, the user interface for interacting with the applications described herein, IM middleware, wireless content browser applications, address book applications, software that facilitates the presentation and interaction with emoticons or similar graphical artifacts, and any other software suitable for operation on the device 4000. In a more robust implementation, the applications 4006 include a voice recognition software that can be trained to learn voice signals of a user. The user can then input message content by voice. Given the availability of such a software, the device 4000 can then be controlled using voice commands that not only facilitate the input of message content, but also facilitate the selection of features provided on the device 4000. For example, a single voice command “smiley!” can be interpreted to insert the smiley emoticon into the message content at the appropriate place.

As will be appreciated by one skilled in the relevant art, such voice interaction algorithms provide numerous additional control capabilities, e.g., turning the device 4000 on or off, initiating a standby mode, accessing an IM account, providing device security where the voice is not recognized by the device 4000, and many more, all of which are within contemplation of the subject invention.

The device 4000 includes interface hardware and software that facilitates interfacing the device 4000 to a subsystem (not shown) or other computing device such that the message(s) can be presented via the subsystem or other computing device. Such interfacing can be provided by way of the serial interface 4012 and/or by the communications component 4008. Thus, a user can bring the device 4000 within communication range of the subsystem or other computing device such that the message can be presented by the other systems, and/or created on the other systems for transmission to the device 4000, and on to the instant messaging network for reception by an intended recipient. Such wireless communications means can include infrared (e.g., IrDA), Bluetooth™, or other similar wireless technologies.

FIG. 41 illustrates a block diagram of a wireless messaging system (WMS) 4100 that uses a mobile messaging gateway server 4102 in accordance with the invention. In this particular implementation, the gateway 4102 is external to the WMD 4000, and operates to provide access between the WMD 4000 and a plurality of providers 4104 (denoted PROVIDER₁, PROVIDER₂, . . . , PROVIDER_{N}) messaging-capable devices. For example, where other suitably-designed devices are provided, the WMD 4000 can communicate messages with at least a second WMD device 4106 (denoted WMD₃), a messaging-capable television 4108, and a messaging-capable gaming console 4110.

The providers 4104 can be any combination of different or similar type of instant messaging provider, e-mail provider, MMS provider, and SMS provider, for example. For example, a first portal 4112 can be an instant messaging provider, a second portal 4114 can be an e-mail provider, and a third portal 4116 can be an SMS provider. Alternatively, by way of example but not by limitation, the providers 4104 can all be e-mail providers, or all SMS providers, or all IM providers. In any case, the gateway 4102 facilitates communication of the different types of messages to the WMD 4000 and from the WMD 4000 to the providers 4104 and associated devices.

A messaging accounting system 4118 interfaces to the gateway 4102 to track costs associated with a given user and the different types of message traffic, and any other related costs for billing a user. It is to be appreciated that the accounting system 4118 can be many subsystems. Moreover, some or all of the providers 4104 can include a separate accounting system 4120 for tracking message traffic and user activities for billing purposes.

It is to be appreciated that the gateway server 4102 can be employed within the WMD 4000 (as indicated supra in FIG. 3) such that account aggregation can be accomplished therein. This further facilitates convenient geographical roaming such that messages can be communicated and processed accordingly from anywhere the user might be.

The system 4100 can also include a computer 4122 that interfaces by conventional communications means to a global communications network 4124 (e.g., the Internet). In support thereof, the user can login to the provider website and perform device activation and many other functions via the website. For example, the user can view account data, payment information and, view and send messages via any of the selected provider portals 4104. The television 4108, gaming console 4110, and computer 4122 can facilitate instant messaging in accordance with the invention by digital means. Thus, when messaging form the WMD 4000 to the television 4108, accounting systems associated with the WMD 4000 can track activities for billing purposes, and/or accounting systems associated with the television 4108 can perform such operations, since such digital traffic can also be monitored by the television systems (not shown). Of course, messaging with the television 4108 need not be via the network 4124, but by cable television systems (not shown). The providers 4104 can communicate wirelessly directly to the gateway 4102, or to the gateway 4102 via the network 4124 (not drawn as such).

The system 4100 can be implemented as a GPRS system based upon GSM. Alternatively, the system 4100 can be implemented on other types of communications systems including, but not limited to UMTS (Universal Mobile Telecommunications Services), EDGE (Enhanced Data for GSM Evolution), CDMA (Code Division Multiple Access), IS-136, and analog systems. IS-136 is also known as Digital AMPS (Advanced Mobile Phone System), succeeds IS-54, and addresses digital cellular systems that employ TDMA. IS-136 also allows analog AMPS to coexist, and specifies a DCCH (Digital Control CHannel) in support of new features controlled by a signaling and control channel between the cell site and the terminal equipment.

Aspects of the invention described above may be stored or distributed on computer-readable media, including magnetic and optically readable and removable computer discs, as microcode on semiconductor memory, nanotechnology memory, organic or optical memory, or other portable data storage media.

The computer-readable media as well, can be distributed electronically over the Internet or over other networks (including wireless networks). Those skilled in the relevant art will recognize that portions or embodiments of the invention may reside in a fixed element of a communication network, while corresponding portions may reside on a mobile communication device. Data structures and transmission of data particular to aspects of the invention are also encompassed within the scope of the invention.

Computer-readable instructions, data structures, screen displays, and other data under aspects of the subject invention can be distributed over a global communications network (e.g., the Internet) or other networks (including wireless networks), or on a propagated signal on a propagation medium (e.g., electromagnetic wave, light wave, sound wave, and so on) over any period of time, or can be provided on any analog or digital network (packet switched, circuit switched, or other information-delivery architecture).

Although not required, aspects of the invention can be described in the context of computer-readable instructions, such as routines executed by a general-purpose computer (e.g., a server computer, wireless device, or personal/portable computer). Those skilled in the relevant art will appreciate that the invention can be practiced with other communications, data processing, or computer configurations, including Internet appliances, hand-held devices (including PDAs), wearable computers, all manner of cellular and/or mobile telephones, embedded computers (including those coupled to vehicles), multi-processor systems, microprocessor-based or programmable consumer electronics, set-top boxes, network PCs, mini-computers, mainframe computers, and the like. Indeed, the terms “computer,” “host,” and “host computer” are generally used interchangeably, and refer to any of the above devices and systems, as well as any data processor.

What has been described above includes examples of the subject invention. It is, of course, not possible to describe every conceivable combination of components or methodologies for purposes of describing the invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A messaging-centric mobile communications system, comprising:
a communications component that facilitates wireless communications of information over an always-on communications network; and
a messaging component that automatically provides status information to the communications component such that the communications network can detect substantially immediately a state of the messaging component.

2. The system of claim 1, wherein the messaging component processes multimedia information.

3. The system of claim 1, wherein the messaging component processes a Short Message Service (SMS) message.

4. The system of claim 1, wherein the messaging component processes an e-mail message.

5. The system of claim 1, wherein the messaging component processes an instant messaging (IM) message.

6. The system of claim 1, wherein the always-on communications network provides a sustained wireless data connection.

7. The system of claim 1, wherein the always-on communications networks provides a buffered/mediated service.

8. The system of claim 7, wherein the buffered/mediated service uses out-of-band signaling to initiate a packet data protocol (PDP) context.

9. The system of claim 1, wherein the messaging component facilitates voice communications.

10. The system of claim 1, wherein the messaging component processes an e-mail message that is received from one of a plurality of accessible e-mail accounts.

11. The system of claim 1, wherein the messaging component processes an IM message that is received from one of a plurality of different accessible IM providers.

12. A personal digital assistant (PDA) according to the system of claim 1.

13. A cellular telephone according to the system of claim 1.

14. A hand-held text-only device according to the system of claim 1.

15. The system of claim 1, wherein the communications component communicates with a dedicated network that supports at least one of PDP and an access point name (APN).

16. The system of claim 1, where the messaging component receives status information of one or more remote users disposed the network.

17. The system of claim 1 facilitates self-provisioning, which self-provisioning is independent of requiring product personnel to assist in activation thereof.

18. The system of claim 1, wherein the messaging component facilitates composing a message without specifying a delivery bearer.

19. The system of claim 1, the messaging component facilitates IM community aggregation such that a message can be communicated via at least one of an e-mail system, an SMS system, an MMS (Multimedia Messaging Service) system, and an IM system.

20. The system of claim 1, further comprising a display that facilitates presentation of the status information to a user.

21. The system of claim 1, wherein the messaging component facilitates generation of a message, and communication of the message to select ones of a plurality of message providers.

22. The system of claim 1, wherein the messaging component facilitates access to at least one of a remote help site and local help information.

23. A mobile terminal that facilitates messaging, comprising:
a memory component that stores at least one of data and instructions related at least in part to processing of a message;
a processing component that interfaces to the memory component to process at least one of the data and the instructions;
a communications component that facilitates wireless communications of status information over an always-on communications network, which status information allows the network to detect substantially immediately a state of the terminal; and
a user interface component that facilitates presentation of the message and creation of a new message.

24. The terminal of claim 23, wherein at least one of the message and the new message comprise,
an e-mail message that is processed according to one of a plurality of different e-mail accounts;
an SMS message that is processed according to one of a plurality of different SMS accounts; and
an IM message that is processed according to one of a plurality of different IM accounts.

25. The terminal of claim 23, wherein the status information facilitates substantially immediate determination of an online status of a remote user.

26. The terminal of claim 23, further comprising a community aggregation component that facilitates access to two or more different messaging providers.

27. The terminal of claim 23, further comprising a provisioning component that facilitates provisioning/deprovisioning of the mobile terminal for always-on wireless communications.

28. The terminal of claim 23, further comprising a messaging gateway that facilitates communications with different messaging provider networks.

29. The terminal of claim 23, further comprising a message composition component that interfaces to the user interface component and facilitates automatic generation of one or more aspects of the message being created.

30. The terminal of claim 23, further comprising an add-on component that facilitates enabling additional services.

31. The terminal of claim 30, the additional services include a voice service such that the mobile terminal can communicate a cellular telephone call.

32. A mobile terminal that facilitates instant messaging, comprising:
a memory component that stores data and instructions related at least in part to processing of a message;
a processing component that interfaces to the memory component to process at least one of the data and the instructions;
a communications component that facilitates always-on wireless communications with an always-on communications network;
a status component that provides status information related to online status of a user of at least one of a same messaging provider and a different messaging provider;
a community aggregation component that facilitates access to two or more of the different messaging providers;
a provisioning component that facilitates self-provisioning of the mobile terminal via the communications network;
a user interface component that facilitates presentation of the message and creation of a new message; and
a message composition component that interfaces to the user interface component and facilitates automatic generation of one or more aspects of the message being created.

33. The terminal of claim 32, wherein the status information is associated with at least one of a user of the mobile terminal and a remote user.

34. The terminal of claim 32, wherein the user interface component facilitates voice interaction with the mobile terminal to interact with one or more functions associated therewith.

35. The terminal of claim 32, wherein the provision component facilitates activation and provisioning by requesting input of personal information of the user.

36. The terminal of claim 32, further comprising a help component that facilitates access to at least one of live help support to resolve a problem, an emergency service, banking information, and IM account information.

37. The terminal of claim 32, further comprising a messaging gateway that facilitates communications with different messaging provider accounts.

38. A system that facilitates instant messaging, comprising:
an always-on communications network that facilitates communication of status information; and
a hand-held messaging-centric terminal disposed in communication with the network and whose status information is automatically communicated to the network such that its status is known substantially immediately to the network.

39. The system of claim 38, further comprising at least one of a personal computer, a PDA, a television, and a gaming console, any one or more of which is disposed in communication with the terminal such that messages can be transmitted therebetween.

40. The system of claim 38, further comprising a plurality of different messaging providers disposed in communication with the network and that provide different corresponding messaging technologies, and all of which communicate with the terminal via the network.

41. The system of claim 38, the terminal communicates wirelessly with the network via a cellular communications network.

42. The system of claim 38, the terminal communicates wirelessly with the network via an Internet.

43. The system of claim 38, further comprising a mobile messaging gateway disposed on the network that facilitates communication between the terminal and at least one of an e-mail provider, an SMS provider, an IM provider, and an MMS provider.

44. A method of mobile messaging using a mobile terminal, comprising:
providing a status component that automatically provides status information associated with a state of the terminal;
providing a messaging component that facilitates presentation and processing of a message and the status information; and
communicating the status information to an always-on communications network such that the state of the terminal is detected substantially immediately by the network.

45. The method of claim 44, further comprising displaying at least one of an SMS message and an IM message.

46. The method of claim 44, further comprising displaying at least one of an e-mail message and an MMS message.

47. The method of claim 44, in response to the status information indicating that the terminal is online:
receiving an e-mail message from one of a plurality of e-mail accounts;
processing the e-mail via the messaging component;
creating a reply e-mail message; and
transmitting the reply e-mail message to one or more of the plurality of e-mail accounts.

48. The method of claim 44, in response to the status information indicating that the terminal is online:
receiving an IM message from one of a plurality of IM accounts;
processing the IM message via the messaging component;
creating a reply IM message; and
transmitting the reply IM message to one or more of the plurality of IM accounts.

49. The method of claim 44, in response to the status information indicating that the terminal is online:
receiving an SMS message from an SMS account;
processing the SMS message via the messaging component;
creating a reply SMS message; and
transmitting the reply SMS message to one or more of a plurality of SMS accounts.

50. The method of claim 44, further comprising automatically formatting a reply message of at least one of an e-mail message, an IM message, and an SMS message for a corresponding delivery bearer.

51. The method of claim 44, further comprising automatically presenting an alert associated with status of a remote user.

52. The method of claim 44, further comprising the acts of:
presenting one or more selections of help information;
interacting with one of the help information selections; and
routing terminal communications to a remote website in order to access the selected help information.

53. The method of claim 44, further comprising presenting an activation wizard that facilitates self-provisioning of the terminal.

54. The method of claim 44, further comprising adding a voice component that facilitates voice communications via the terminal.

55. The method of claim 54, further comprising controlling the terminal via the voice component.

56. A method of mobile messaging using a mobile terminal, comprising:
automatically communicating to an always-on communications network status information associated with a state of the terminal such that the state of the terminal is detected substantially immediately by the network;
in response to the status information indicating that the state of the terminal is online, accessing a messaging provider account;
processing a message of the provider account; and
providing an indicator that the message is available for perceiving.

57. The method of claim 56, the act of processing includes one or more of the acts of:
downloading an IM message;
downloading an e-mail message; and
downloading an SMS message.

58. The method of claim 56, further comprising perceiving the message by at least one of visually and audibly.

59. The method of claim 56, further comprising provisioning the terminal by one or more of the acts of:
activating the terminal wirelessly;
activating the terminal via a personal computer;
inputting user information;
selecting a rate plan;
creating a user account; and
receiving credentials that facilitate access to the user account.

60. The method of claim 56, further comprising provisioning the terminal by inserting a replacement Subscriber Identity Module (SIM) that includes account information.

61. The method of claim 56, further comprising provisioning the terminal by inserting a SIM and downloading account information from the SIM.

62. The method of claim 56, further comprising synchronizing with the network to send and receive the message.

63. The method of claim 56, further comprising configuring a default synchronization schedule.

64. The method of claim 56, further comprising authenticating to the messaging provider account.

65. The method of claim 56, further comprising sending an alert if the message is exceeds a predetermined size.

66. A messaging-centric mobile terminal, comprising:
a memory that stores data and instructions;
a processor that accesses the memory to process the data and the instructions;
an input/output (I/O) component that couples to the processor and facilitates user interaction with the terminal;
a transceiver subsystem that facilitates wireless communications with an always-on communications network;
a display that presents at least one of the data and instructions in the form of display descriptions;
an applications component that includes,
a status application which provides terminal status information that is communicated over the network, and receives remote user status information from the network about the status of one or more remote users;
a user interface that facilitates presentation of the display descriptions in a user interactive format;
a composition component that facilitates composing a message; and
an aggregation component that facilitates message processing from two or more different messaging providers, and access thereto by the user interface;
an audio I/O component that facilitates audio output and voice input;
a power source; and
a clamshell housing that supports the memory, the processor, the I/O component, the transceiver subsystem, the display, the applications component, the audio I/O component, and the power source.

67. The terminal of claim 66, wherein one potion of the clamshell housing supports a color LCD display and the audio I/O component, and the other potion supports the I/O component, which is a QWERTY keyboard.

68. The terminal of claim 66, further comprising a SIM card that stores user account information.

69. The terminal of claim 66, the transceiver subsystem communicates 850 MHz and 1900 MHz GSM/GPRS signals.

70. The terminal of claim 66, the memory caches user credentials that are used for authentication of the terminal to the network.
